(19) United States
(12) Patent Application Publication
(10) Pub. No.: US 2006/0026171 A1
(43) Pub. Date: Feb. 2, 2006

(54) Content distribution and synchronization

(75) Inventor: James A. Savage, San Jose, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Mirra, Inc.

(21) Appl. No.: 11/178,131

(22) Filed: Jul. 8, 2005

Related U.S. Application Data
(60) Provisional application No. 60/592,671, filed on Jul. 30, 2004.
(60) Provisional application No. 60/592,633, filed on Jul. 30, 2004.
(60) Provisional application No. 60/592,632, filed on Jul. 30, 2004.

(51) Int. Cl. G06F 17/30

(52) U.S. Cl. 707/10

(57) ABSTRACT

A content management system may include a plurality of computing devices. One or more content management modules may manage content-related events among the computing devices, the appliances, or both. The content management modules may apply one or more rules to manage the content-related events. The content-related events may help provide various content relationships, such as content backup and content subscription.

### CROSS-REFERENCE TO RELATED APPLICATIONS

This applications claims priority to and the benefit of U.S. Provisional Application No. 60/592,671, filed Jul. 30, 2004 and entitled CONTENT DISTRIBUTION AND SYNCHRONIZATION, and U.S. Provisional Application No. 60/592,633, filed Jul. 30, 2004 and entitled AUTHENTICATING CLIENT-TO-CLIENT COMMUNICATION, which are hereby incorporated by reference herein in its entirety. This application is also related to U.S. Provisional Patent Application No. 60/592,632, filed Jul. 30, 2004 entitled SERVER-ASSISTED COMMUNICATION AMONG CLIENTS, which is hereby incorporated by reference herein in its entirety.

### BACKGROUND OF THE INVENTION

1. Field of the Invention

The present invention relates generally to communication. More specifically, the present invention relates to systems and methods for content distribution, content synchronization, and other suitable activities.

2. Related Technology

Computer and data communications networks continue to proliferate. Such networks—including wide area networks (“WANs”) and local area networks (“LANs”)—help increase productivity through sharing resources and transferring (or otherwise processing) voice and data. For example, in many systems, a file server may be connected to a network. Once connected to the network, a plurality of computers may access the file server to store and/or revise data files on the file server.

In some systems, computers may remotely access a file server, allowing a variety of persons in a variety of remote locations to collaborate on the same file. However, unreliable networks, unreliable hardware, and limited bandwidth can limit the effective collaboration in these systems. Further, because many businesses and individuals use incompatible networks, accessing the file server can often be difficult.

Accordingly, to collaborate, many persons choose to manually distribute original copies and any subsequent revisions using electronic mail (“e-mail”). Of course, this practice requires a person to diligently remember to circulate versions regularly to ensure that the other collaborators may see the latest revisions. Also, this requires a user to remember to address the e-mail to each recipient. This can be frustrating and time consuming for users that frequently share different files among different groups. Further, in some instances, attaching files to an e-mail message may result in truncated and/or corrupted files. Lastly, sending files via e-mail can waste a significant amount of storage space on an e-mail server—requiring users and/or system administrators to delete messages more often.

In some systems, computers may access a file server, allowing a person manually store a redundant copy of a data file on the file server. While helping to avoid some loss of data, this practice requires a person to diligently remember to store backups regularly to minimize data loss. Further, even with systems that backup data on scheduled intervals, the data loss between intervals can be significant.

### BRIEF SUMMARY OF EMBODIMENTS OF THE INVENTION

A need therefore exists for systems and methods that reduce some of the above-described disadvantages and problems, reduce all of the above-described disadvantages and problems, and/or reduce other disadvantages and problems.

In one embodiment, one or more appliances and/or one or more computing devices may communicate in a network. An appliance or a computing device may include a content management module configured to distribute and/or to synchronize content for backup purposes, for collaboration purposes, or for any other suitable purpose.

In one embodiment, the content management modules may manage content-related events among the computing devices, the appliances, or both. The content management modules may apply one or more rules to manage the content-related events. The content-related events may help provide various content relationships, such as content backup, content subscription, or any other suitable content relationships.

For purposes of summarizing, some aspects, advantages, and novel features have been described. Of course, it is to be understood that not necessarily all such aspects, advantages, or features will be embodied in any particular embodiment of the invention. Further, embodiments of the invention may comprise aspects, advantages, or features other than those that have been described. Some aspects, advantages, or features of embodiments of the invention may become more fully apparent from the following description and appended claims or may be learned by the practice of embodiments of the invention as set forth in this disclosure.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. Certain embodiments of the invention will be described and explained with additional specificity and detail through the use of the accompanying drawings in which:

FIG. 1A is a block diagram illustrating an exemplary embodiment of a networking system;

FIG. 1B is a block diagram illustrating an embodiment of the networking system shown in FIG. 1A;

FIG. 2A is a flowchart illustrating an exemplary method that may be performed using the networking system shown in FIG. 1A;

FIG. 2B is a flowchart illustrating an exemplary method that may be performed using the networking system shown in FIG. 1A;

FIG. 3B is a block diagram of the networking system shown in FIG. 1A in which aspects of the methods shown in FIG. 2A and FIG. 3A may be performed;

FIG. 3C is a block diagram of the networking system shown in FIG. 1A in which aspects of the methods shown in FIG. 2A and FIG. 3A may be performed;

FIG. 3D is a flowchart illustrating an exemplary method that may be performed using the networking system shown in FIG. 1A;

FIG. 3E is a block diagram of the networking system shown in FIG. 1A in which aspects of the methods shown in FIGS. 2A and 3D may be performed;

FIG. 4A is a flowchart illustrating an exemplary method that may be performed using the networking system shown in FIG. 1A;

FIG. 4B is a block diagram of the networking system shown in FIG. 1A in which aspects of the methods shown in FIGS. 2A and 4A may be performed;

FIG. 4C is a flowchart illustrating an exemplary method that may be performed using the networking system shown in FIG. 1A;

FIG. 4D is a block diagram of the networking system shown in FIG. 1A in which aspects of the methods shown in FIGS. 2A and 4C may be performed;

FIG. 5A is a flowchart illustrating an exemplary method that may be performed using the networking system shown in FIG. 1A;

FIG. 5B is a block diagram of the networking system shown in FIG. 1A in which aspects of the methods shown in FIGS. 2A and 5A may be performed;

FIG. 5C is a flowchart illustrating an exemplary method that may be performed using the networking system shown in FIG. 1A;

FIG. 5D is a block diagram of the networking system shown in FIG. 1A in which aspects of the methods shown in FIGS. 2A and 5C may be performed;

FIG. 6A is a flowchart illustrating an exemplary method that may be performed using the networking system shown in FIG. 1A;

FIG. 6B is a block diagram of the networking system shown in FIG. 1A in which aspects of the methods shown in FIGS. 2A and 6A may be performed;

FIG. 6C is a flowchart illustrating an exemplary method that may be performed using the networking system shown in FIG. 1A;

FIG. 6D is a block diagram of the networking system shown in FIG. 1A in which aspects of the methods shown in FIGS. 2A and 6C may be performed;

FIG. 7A is a flowchart illustrating an exemplary method that may be performed using the networking system shown in FIG. 1A;

FIG. 7B is a flowchart illustrating an exemplary method that may be performed using the networking system shown in FIG. 1A;

FIG. 8A is a flowchart illustrating an exemplary method that may be performed using the networking system shown in FIG. 1A;

FIG. 8B is a block diagram of the networking system shown in FIG. 1A in which aspects of the methods shown in FIGS. 7A and 8A may be performed;

FIG. 8C is a flowchart illustrating an exemplary method that may be performed using the networking system shown in FIG. 1A;

FIG. 8D is a block diagram of the networking system shown in FIG. 1A in which aspects of the methods shown in FIGS. 7A and 8C may be performed;

FIG. 8E is a block diagram of the networking system shown in FIG. 1A in which aspects of the methods shown in FIGS. 7A and 8C may be performed;

FIG. 9A is a flowchart illustrating an exemplary method that may be performed using the networking system shown in FIG. 1A;

FIG. 9B is a block diagram of the networking system shown in FIG. 1A in which aspects of the methods shown in FIGS. 7A and 9A may be performed;

FIG. 9C is a flowchart illustrating an exemplary method that may be performed using the networking system shown in FIG. 1A;

FIG. 9D is a block diagram of the networking system shown in FIG. 1A in which aspects of the methods shown in FIGS. 7A and 9C may be performed;

FIG. 9E is a block diagram of the networking system shown in FIG. 1A in which aspects of the methods shown in FIGS. 7A and 9C may be performed;

FIG. 9F is a block diagram of the networking system shown in FIG. 1A in which aspects of the methods shown in FIGS. 7A and 9C may be performed;

FIG. 10A is a block diagram of the networking system shown in FIG. 1A in which aspects of the methods shown in FIGS. 7A and 9C may be performed;

FIG. 10B is a block diagram of the networking system shown in FIG. 1A in which aspects of the methods shown in FIGS. 7A and 9C may be performed;

FIG. 10C is a block diagram of the networking system shown in FIG. 1A in which aspects of the methods shown in FIGS. 7A and 9C may be performed;

FIG. 10D is a block diagram of the networking system shown in FIG. 1A in which aspects of the methods shown in FIGS. 7A and 9C may be performed;

FIG. 10E is a block diagram of the networking system shown in FIG. 1A in which aspects of the methods shown in FIGS. 7A and 9C may be performed;

FIG. 11A is a block diagram that illustrates an embodiment of the networking system shown in FIG. 1A in which appliances may be optional;

FIG. 11B is a block diagram that illustrates an embodiment of the networking system shown in FIG. 1A in which appliances may be optional;

FIG. 11C is a block diagram that illustrates an embodiment of the networking system shown in FIG. 1A in which appliances may be optional;

FIG. 11D is a block diagram that illustrates an embodiment of the networking system shown in FIG. 1A in which appliances may be optional;

FIG. 12A is a flowchart illustrating an exemplary method that may be performed using the networking system shown in FIG. 1A;

FIG. 12B is a block diagram of an embodiment of the networking system shown in FIG. 1A in which aspects of the method shown in FIG. 12A may be performed;

FIG. 12C is a block diagram of an embodiment of the networking system shown in FIG. 1A in which aspects of the method shown in FIG. 12A may be performed;

FIG. 12D is a block diagram of an embodiment of the networking system shown in FIG. 1A in which aspects of the method shown in FIG. 12A may be performed; and

FIG. 12E is a block diagram of an embodiment of the networking system shown in FIG. 1A in which aspects of the method shown in FIG. 12A may be performed.

### DETAILED DESCRIPTION OF THE PREFERRED EMBODIMENTS

Exemplary Networking System

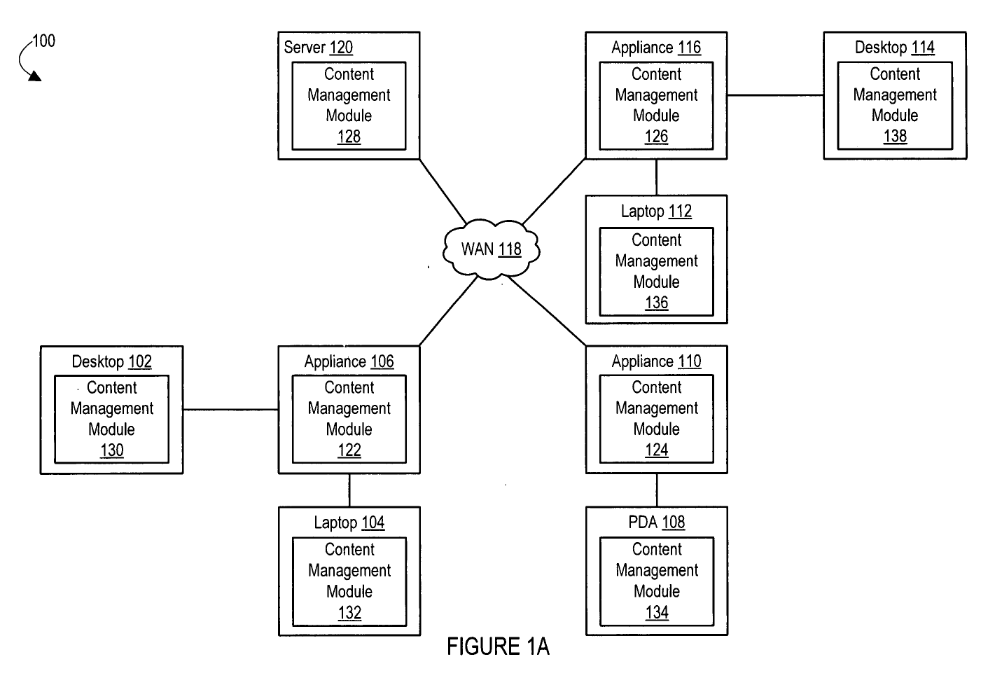

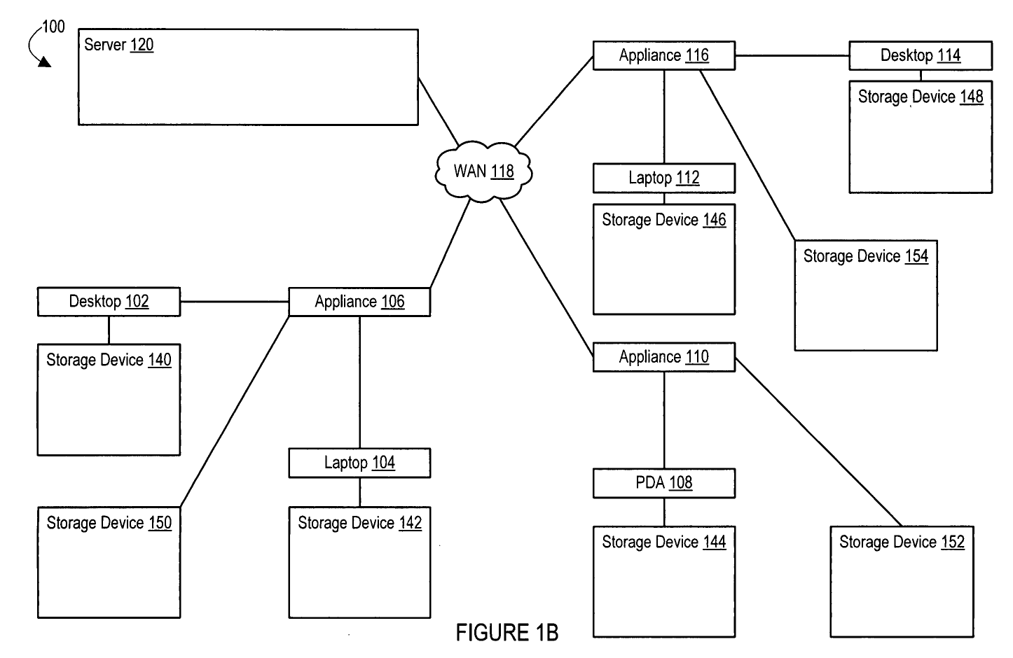

FIG. 1A is a block diagram illustrating an exemplary embodiment of a networking system 100 for implementing embodiments of the present invention. The networking system 100 may include one or more computing devices. As used herein, “computing device” is a broad term and is used in its ordinary meaning and may include, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

As shown in FIG. 1A, the networking system 100 may include one or more appliances 106, 116, and 110, which are also examples of computing devices. Each appliance 106, 110, and 116 may be associated with one or more other computing devices. For example, a desktop computer 102 and a laptop computer 104 may be connected to the appliance 106; a PDA 108 may be connected to the appliance 110; and a laptop computer 112 and a desktop computer 114 may be connected to the appliance 116. Generally, each appliance can be associated with multiple computing devices and each computing device can be associated with multiple appliances.

As further illustrated in FIG. 1A, an appliance and any associated computing devices may be interconnected to form a network, such as a local area network. For example, the desktop computer 102, the laptop computer 104, and the appliance 106 may comprise a local area network; the PDA 108 and the appliance 110 may comprise a local area network; and the laptop computer 112, the desktop computer 114, and the appliance 116 may comprise a local area network. An appliance and any associated computing devices may be interconnected using any other suitable network including, but not limited to, a local area network, a WAN, the Internet, any other network, any other connection, or any combination thereof. Also, an appliance and any associated computing devices may be interconnected using one or more wired and/or wireless connections, if desired.

As shown in FIG. 1A, the networking environment 100 may include one or more networks, such as a network 118. The network 118 may comprise of a plurality of linked local area networks. Although illustrated as a wide-area network (WAN), the network 118 may comprise a local area network, a WAN, the Internet, any other network, any other connection, or any combination thereof. The networking environment 100 does not require the network 118. As shown in FIG. 1A, appliances, computing devices, servers, or a combination thereof may advantageously communicate via the network 118. In addition, the network 118 may be geographically widespread such that any appliance or computing device may be geographically remote from another appliance or associated computing device. An appliance and/or the appliance's associated computing devices may be positioned in any number of other suitable locations with respect to another appliance and/or one or more of its associated computing devices.

As shown in FIG. 1A, the networking environment 100 may include a server 120, which may comprise one or more servers that may include one or more hardware modules, one or more software modules, or both.

The networking environment 100 may include a content management system. The content management system may advantageously provide communication features, content creation features, content transfer features, content backup features, content sharing features, content distribution features, content synchronization features, any other suitable features, or any suitable combination thereof. As used herein, “content” is a broad term and is used in its ordinary meaning and includes, but is not limited to, software, documents, data, information, electronic files, any electronic materials that may be useful or desirable to backup, any electronic materials that may be useful or desirable to distribute in a network environment, any electronic materials that may be useful or desirable to synchronize in a network environment, any electronic materials that may be useful or desirable to make accessible from a remote location, any other electronic materials that may be useful or desirable to employ embodiments of the invention, and the like. The content management system may comprise a distributed system. The content management system may comprise one or more modules, which may comprise hardware components, software components, or both. The content management system may be implement using one or more computing devices, one or more appliances, one or more servers, or a combination thereof.

For example, the appliance 106 may include a content management module 122; the appliance 110 may include a content management module 124; and the appliance 116 may include a content management module 126. Similarly, a computing device, a server, or both may include module(s) related to content management as described herein. For example, the server 120 may include a content management module 128; the desktop 102 may include a content management module 130; the laptop 104 may include a content management module 132; the PDA 108 may include a content management module 134; the laptop 112 may include a content management module 136; and the desktop 114 may include a content management module 138.

FIG. 1B is a block diagram illustrating an embodiment of the networking environment 100 in which appliances, computing devices, or both may include one or more associated storage devices or have access to storage devices (hard drives, Random access memory, flash memory, and the like) either locally or remotely. For example, the desktop 102 may include a storage device 140; the laptop 104 may include a storage device 142; the PDA 108 may include a storage device 144; the laptop 112 may include a storage device 146; and the desktop 114 may include a storage device 148. Similarly, the appliance 106 may include a storage device 150; the appliance 110 may include a storage device 152; and the appliance 116 may include a storage device 154.

Backup & Synchronization

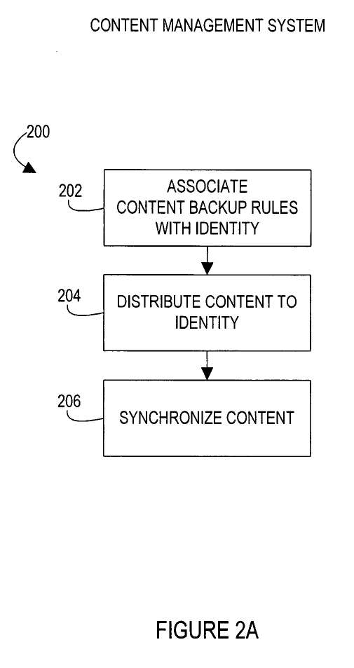

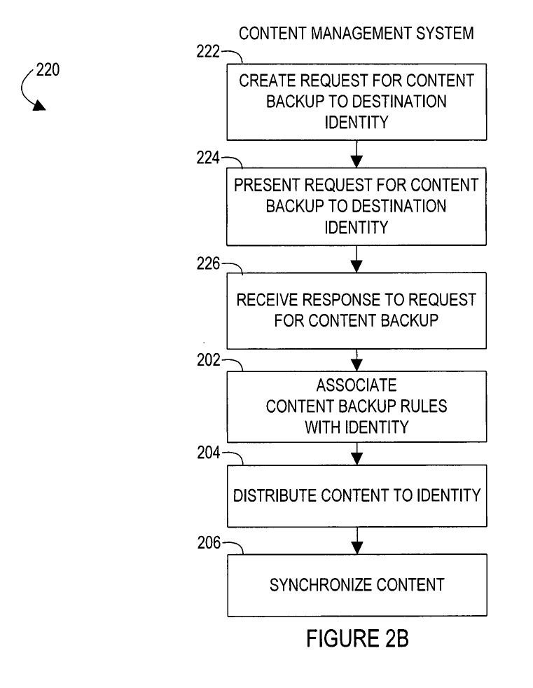

FIG. 2A is a flowchart illustrating an exemplary method 200 for synchronizing content in a networking environment such as shown in FIGS. 1A and 1B. At a block 202, a content management system may create one or more content-management rules. The content-management rules may be identity-based, event-driven, or both. For example, the content management rules may associate one or more backup-related actions to be performed in response to one or more events. Exemplary events may include, but are not limited to, one or more of the following: content creation; content receipt; content modification; content deletion; content encryption; content download; content upload; content conversion; content corruption; virus detection; establishment of communication between a local device and the networking environment 100; establishment of communication between a remote device and the networking environment 100; passage of a predetermined period of time; a user logon to a device in the networking environment 100; a user logoff from a device in the networking environment 100; and any other suitable event. The content management rules may identify one or more backup-related actions to be performed in response to one or more events, in response to metadata associated with content, in response to other suitable factors, or any suitable combination thereof.

At a block 204, the content management system may distribute content to one or more identities, including one or more persons or discrete entities (such as, an application, a service, a module, an appliance, a computing device, or the like) that may be capable of accessing or otherwise interacting with content. At a block 206, the content management system may synchronize content by, for example, providing a version of the content to an identity. The content management system may synchronize content in response to any suitable event, such as, for example, content modification. Thus, in one exemplary embodiment, in response to modification of the content on a storage device associated with a source computing device, the content management system may provide a modified version of the content to an identity.

FIG. 2B is a flowchart illustrating an exemplary method 220 for synchronizing content. At a block 222, the content management system may create one or more requests for content backup, which may be presented to a destination identity, a user of a destination identity, or the like. For example, the content management system may receive, via a first user interface, user input indicating a first user's desire to store content for backup purposes on one or more computing devices, appliances, or the like. At a block 224, the content management system may present the one or more requests for content backup to a destination identity, a user of a destination identity, or the like. For example, the content management system may, via a second user interface, display (to a user of an appliance, a user of a computing device, or the like) the first user's desire to store content. At a block 226, the content management system may receive (from a destination identity, a user of a destination identity, or the like) one or more responses to the one or more requests for content backup. For example, the content management system may receive, via the second user interface, user input indicating that the user of an appliance, a user of a computing device, or the like will permit (or will not permit) the requested content backup. As shown in FIG. 2B, if the user input indicates that the user of an appliance, a user of a computing device, or the like will permit the requested content backup, the content management system may perform some or all of the method 200 (FIG. 2A), which may comprise the blocks 202, 204, and 206.

Local Appliance Content Backup

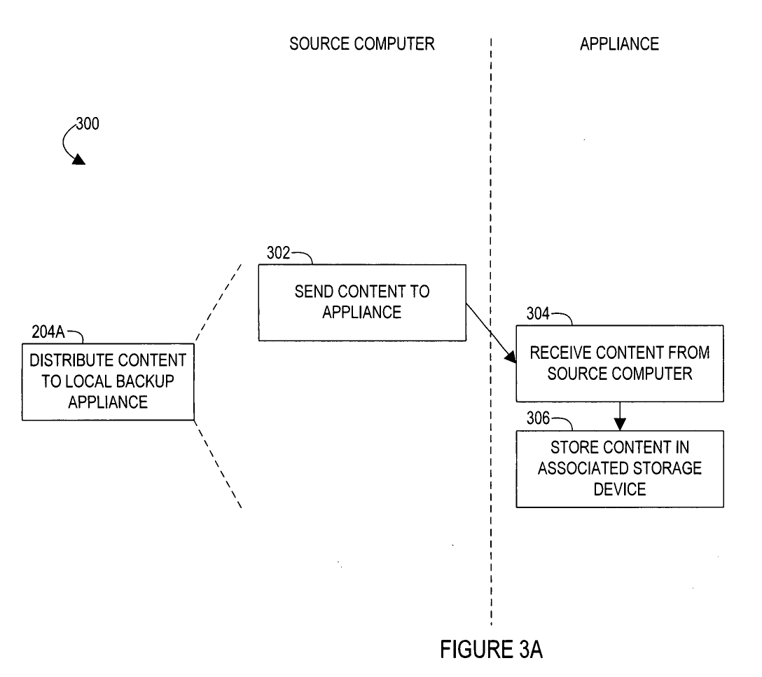

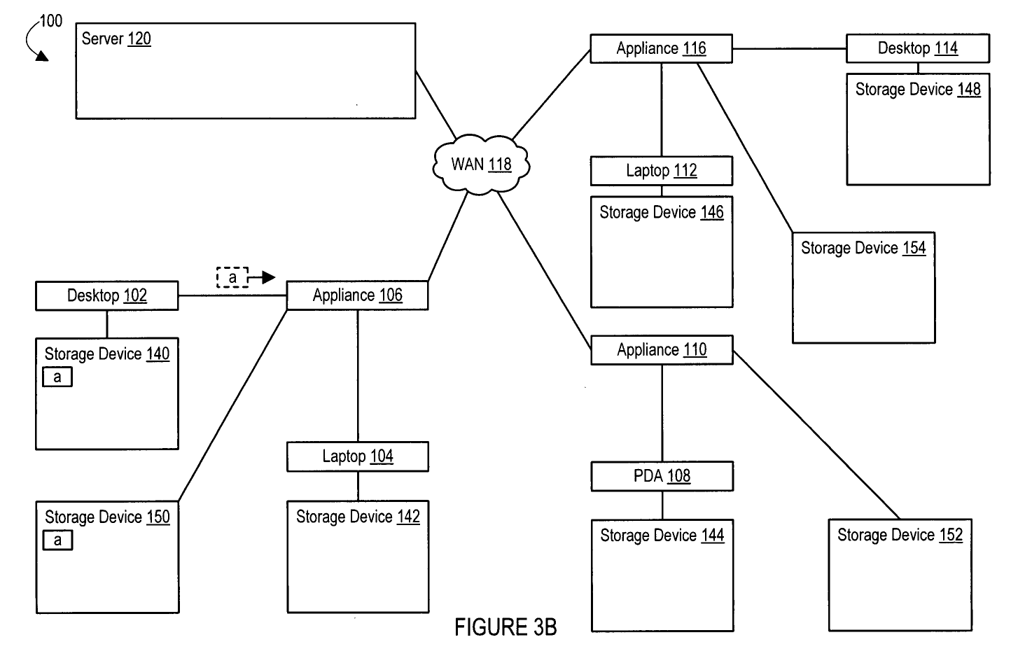

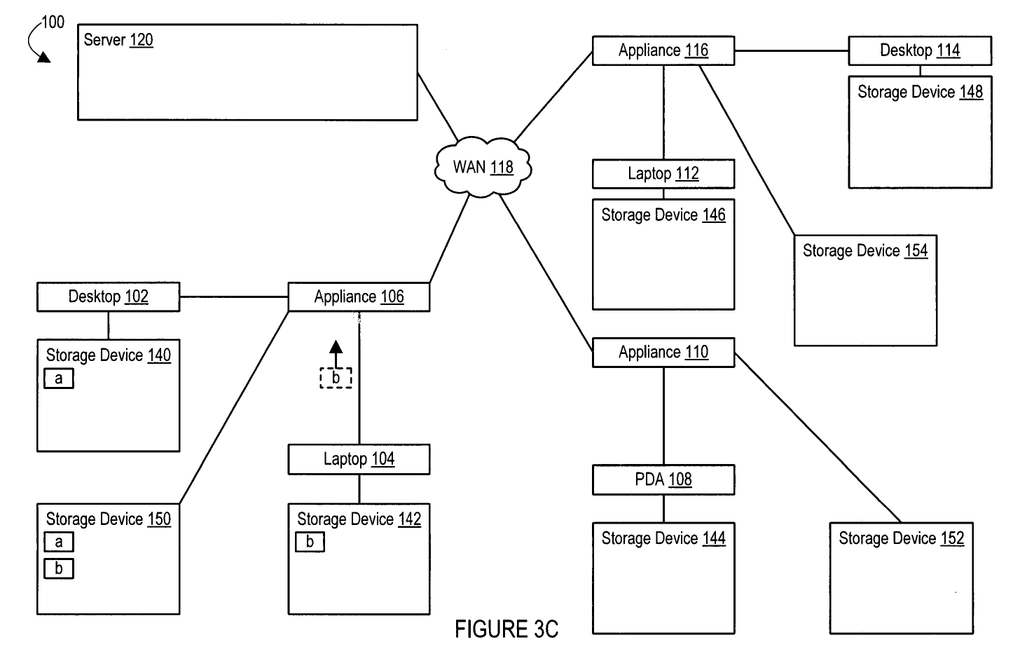

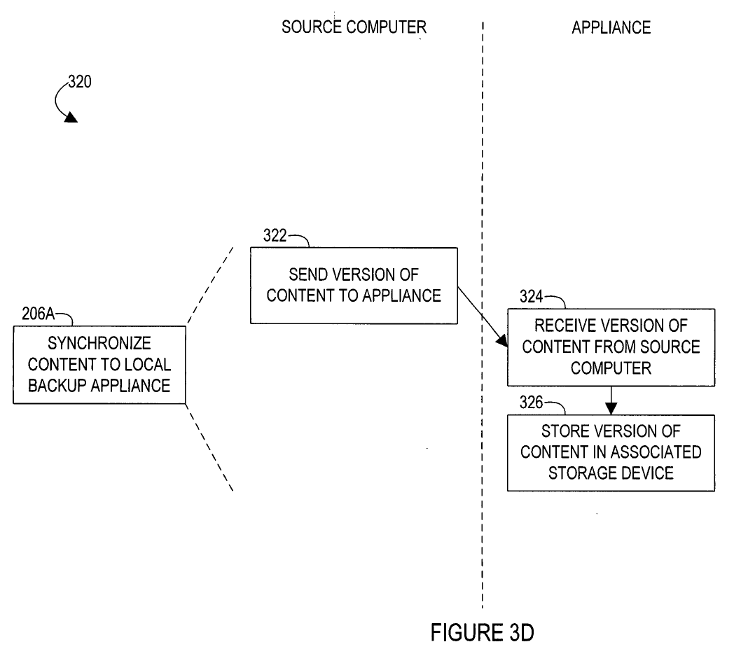

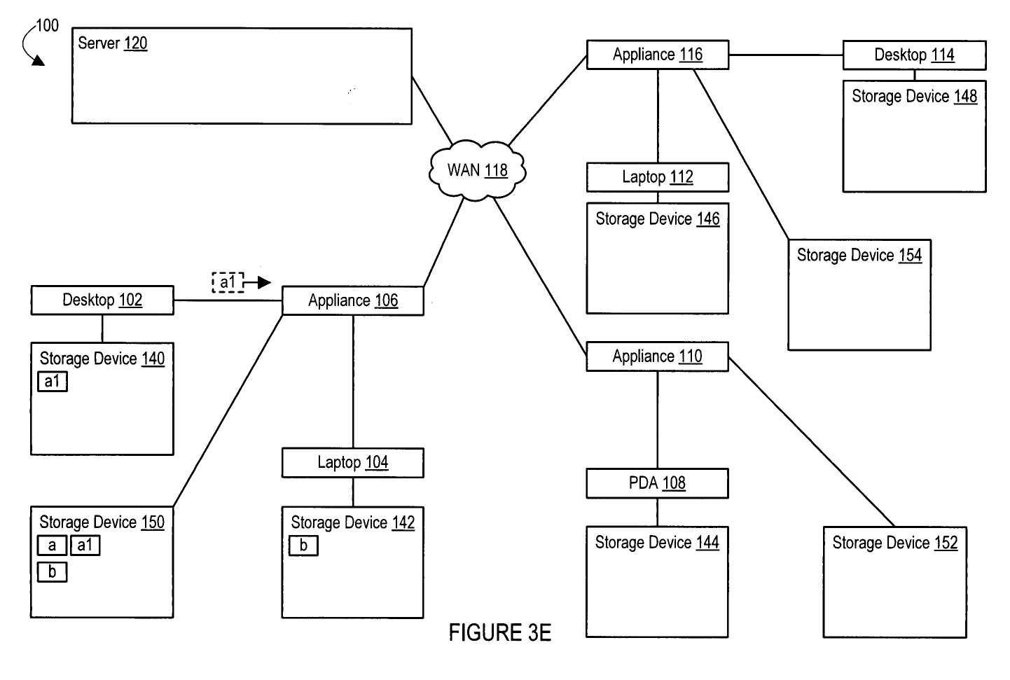

FIG. 3A is a flowchart illustrating an exemplary method 300 that may be performed using any suitable system, such as, the networking environment 100 shown in FIGS. 1A and 1B. In one embodiment, a content management system (such as, one or more the content management modules 122, 124, 126, 128, 130, 132, 134, 136, 138 shown in FIG. 1A) may perform some or all of the method 300. Of course, the method 300 may be performed by any other suitable system and in any other suitable environment.

In one embodiment, the block 204 (FIG. 2A) may comprise a block 204A (FIG. 3A) in which the content management system may distribute a copy of content to a local appliance for backup purposes or the like. As shown in FIG. 3A, the block 204A may comprise one or more blocks. At a block 302, a content management module for the source computer may send a copy of the content to a local appliance. At a block 304, a content management module for the local appliance may receive the copy of the content and, at a block 306, may store the copy of the content in a storage device associated with the local appliance.

FIGS. 3B and 3C are block diagrams of the networking environment 100 (FIGS. 1A and 1B) in which some or all aspects of the methods 200 (FIG. 2A) and 300 (FIG. 3A) may be performed. As shown in FIG. 3B, a file “a” may be stored on the storage device 140 of the desktop 102. As shown in FIGS. 1A and 3B, the content management module 130 for the desktop 102 may send a copy of the file “a” to the appliance 106. The content management module 122 for the appliance 106 may receive the copy of the file “a” and may store the copy of the file “a” in the storage device 150. As shown in FIG. 3C, a file “b” may be stored on the storage device 142 of the laptop 104. As shown in FIGS. 1A and 3C, the content management module 132 for the laptop 104 may send a copy of the file “b” to the appliance 106. The content management module 122 for the appliance 106 may receive the copy of the file “b” and may store the copy of the file “b” in the storage device 150.

Synchronization of Local Appliance Content Backup

FIG. 3D is a flowchart illustrating an exemplary method 320 that may be performed using any suitable system, such as, the networking environment 100 shown in FIGS. 1A and 1B. In one embodiment, a content management system may perform some or all of the method 320. Of course, the method 320 may be performed by any other suitable system and in any other suitable environment.

In one embodiment, the block 206 (FIG. 2A) may comprise a block 206A (FIG. 3D) in which the content management system may synchronize content to a local appliance. As shown in FIG. 3D, the block 206A may comprise one or more blocks. At a block 322, a content management module for the source computer may send a version of the content to a local appliance. At a block 324, a content management module for the local appliance may receive the version of the content and, at a block 326, may store the version of the content in a storage device associated with the local appliance. In response to receiving the received version of the content, the content management module for the local appliance may delete a prior version of the content. In one embodiment, the content management module for the local appliance may, when the received version of the content exceeds a predetermined limit of versions, delete a prior version of the content (such as, the oldest prior version) in response to receiving the received version. The content management module for the local appliance may store any suitable number of versions (such as, 1, 2, 3, 4, 5, 6, 7, 8, or more versions) for any suitable number of files from any suitable number of computing devices. Of course, the content management module for the local appliance need not store multiple versions and may, for example, delete any prior version of the content in response to receiving the received version.

FIG. 3E is a block diagram of the networking environment 100 (FIGS. 1A and 1B) in which some or all aspects of the methods 200 (FIG. 2A) and 320 (FIG. 3D) may be performed. As shown in FIGS. 3C and 3E, the file “a” stored on the storage device 140 (FIG. 3C) may be modified to another version—a file “a1” stored on the storage device 140 (FIG. 3E).

In various examples in this application, a file may be referred to as file “a,” file “b,” file “c,” and so forth. In these examples, subsequent versions of files typically will include a number corresponding to a version, such as, file “a1” for the first subsequent version and “a2” for the second subsequent version. It will be appreciated that such labels as “a1” and “a2” are used for convenience only. Accordingly, if desired, subsequent versions of files could be named the same as, similar to, or entirely different from prior versions of files.

As shown in FIGS. 1A and 3E, the content management module 130 for the desktop 102 may send a copy of the file “a1” to the appliance 106. The content management module 122 for the appliance 106 may receive the copy of the file “a1” and may store the copy of the file “a1” in the storage device 150.

Local Computing Device Content Backup

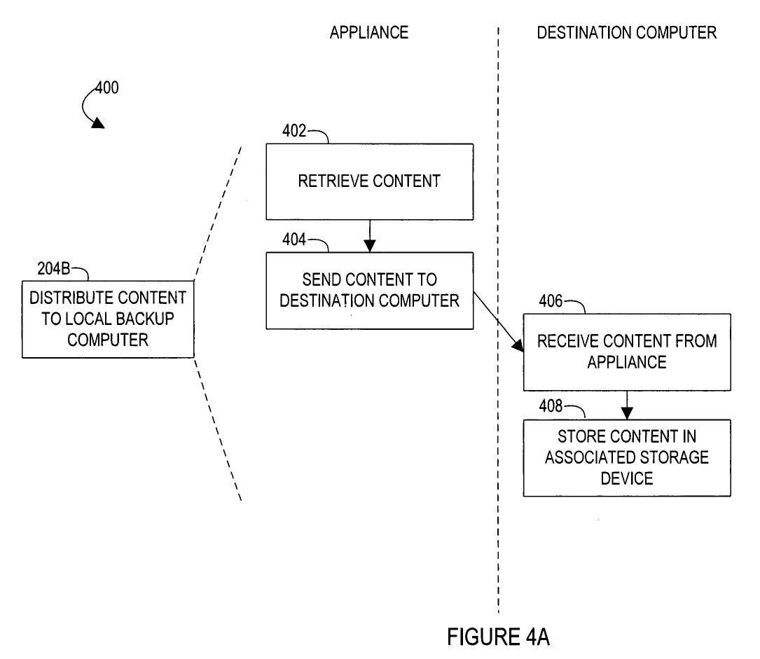

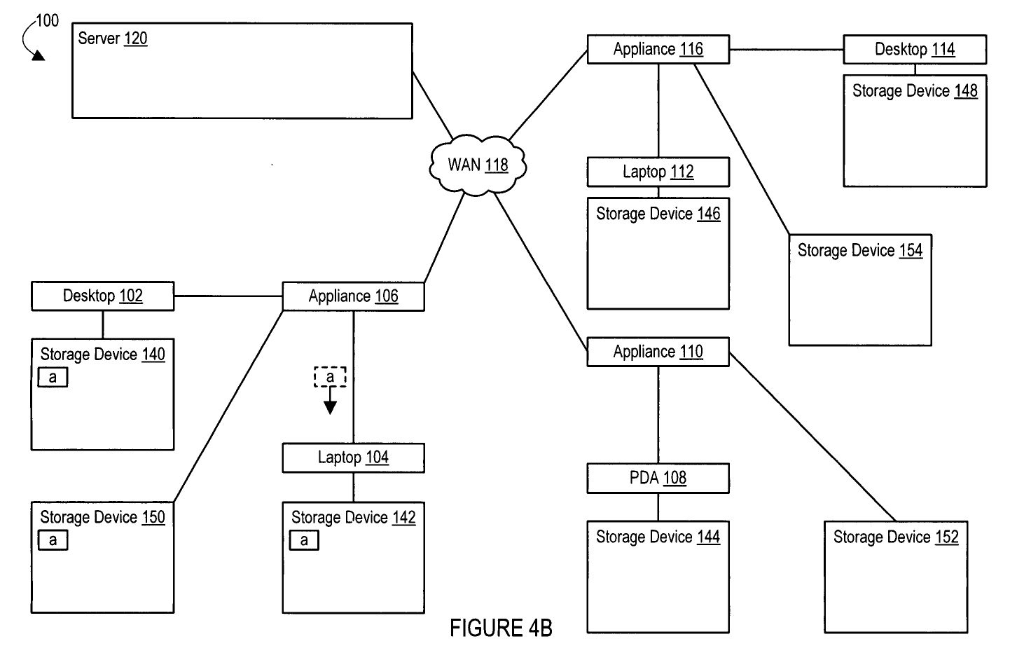

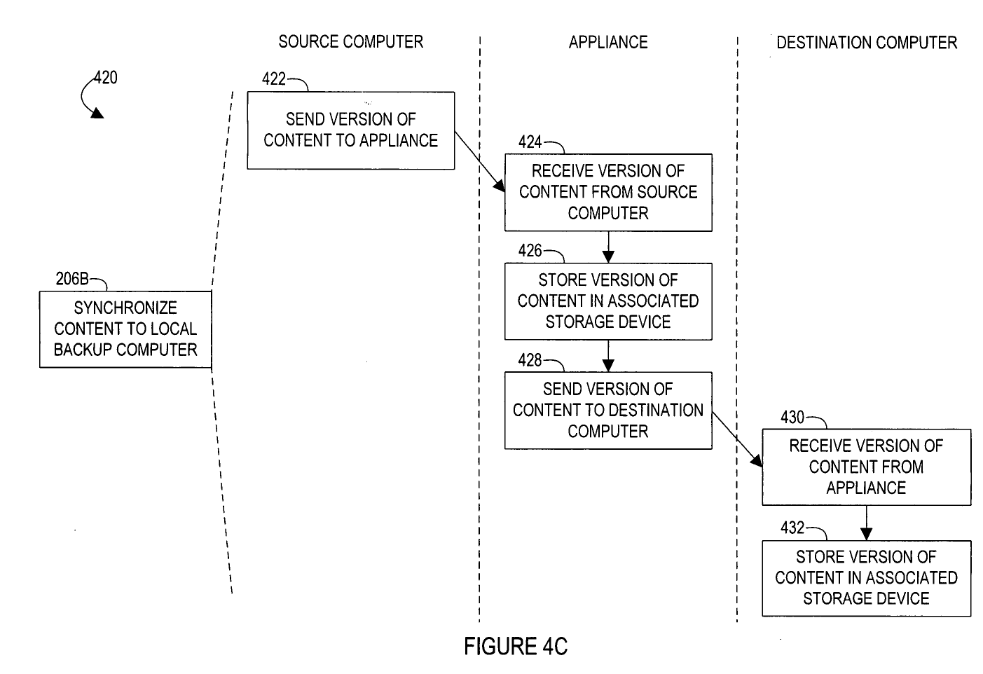

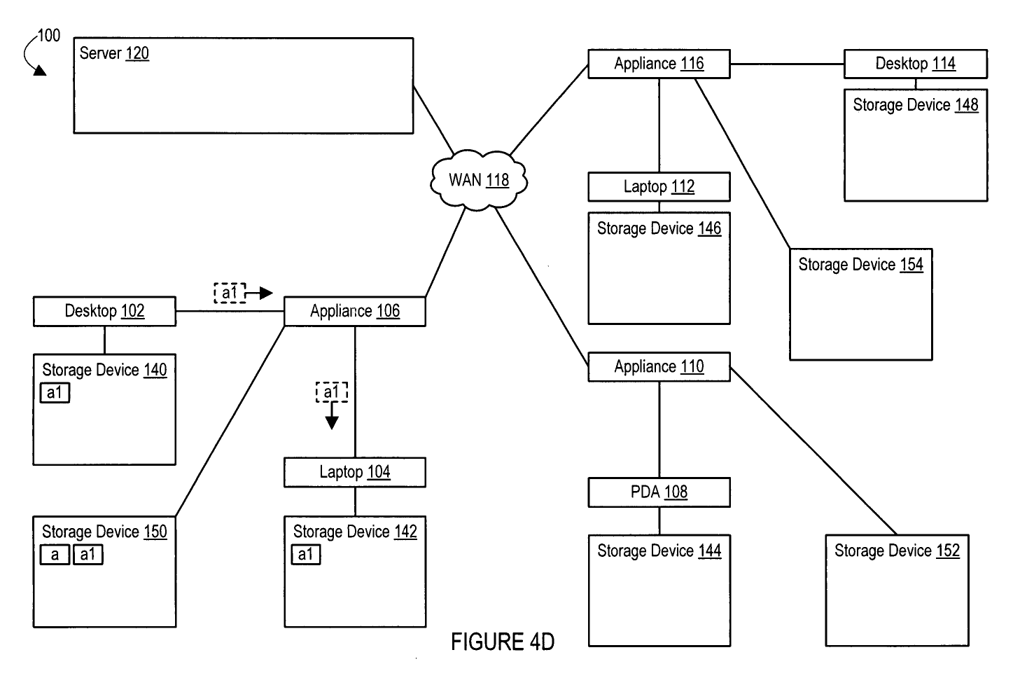

FIG. 4A is a flowchart illustrating an exemplary method 400 that may be performed using any suitable system, such as, the networking environment 100 shown in FIGS. 1A and 1B. In one embodiment, a content management system may perform some or all of the method 400. Of course, the method 400 may be performed by any other suitable system and in any other suitable environment.

In one embodiment, the block 204 (FIG. 2A) may comprise a block 204B (FIG. 4A) in which the content management system may distribute a copy of content to a local computing device (such as, a local computer) for backup purposes or the like. As shown in FIG. 4A, the block 204B may comprise one or more blocks. At a block 402, a content management module for an appliance may retrieve a copy of the content from a suitable resource (such as, a storage device associated with the appliance, a content management module for a source computer, or the like). At a block 404, the content management module for the local appliance may send the copy of the content to a local computer. At a block 406, a content management module for the local computer may receive the copy of the content and, at a block 408, may store the copy of the content in a storage device associated with the local computer.

FIG. 4B is a block diagram of the networking environment 100 (FIGS. 1A and 1B) in which some or all aspects of the methods 200 (FIG. 2A) and 400 (FIG. 4A) may be performed. As shown in FIG. 4B, a file “a” may be stored on the storage device 140 of the desktop 102, may be stored on the storage device 150 of the appliance 106, or both.

As shown in FIGS. 1A and 4B, the content management module 122 for the appliance 106 may retrieve a copy of the file “a.” The content management module 122 may retrieve a copy of the file “a” from the storage device 150. To retrieve a copy of the file “a,” the content management module 122 may request a copy of the file “a” from the content management module 130 for the desktop 102, which may retrieve a copy of the file “a” from the storage device 140 and send that copy to the content management module 122. The content management module 122 may retrieve a copy of the file “a” in any other suitable manner.

As shown in FIGS. 1A and 4B, the content management module 122 may send a copy of the file “a” to the laptop 104. The content management module 132 for the laptop 104 may receive the copy of the file “a” and may store the copy of the file “a” in the storage device 142.

Synchronization of Local Computing Device Content Backup

FIG. 4C is a flowchart illustrating an exemplary method 420 that may be performed using any suitable system, such as, the networking environment 100 shown in FIGS. 1A and 1B. In one embodiment, a content management system may perform some or all of the method 420. Of course, the method 420 may be performed by any other suitable system and in any other suitable environment.

In one embodiment, the block 206 (FIG. 2A) may comprise a block 206B (FIG. 4C) in which the content management system may synchronize content to a local computing device (such as, a local computer). As shown in FIG. 4C, the block 206B may comprise one or more blocks. At a block 422, a content management module for the source computer may send a version of the content to a local appliance. At a block 424, a content management module for the local appliance may receive the version of the content and, at a block 426, may store the version of the content in a storage device associated with the local appliance. In response to receiving the received version of the content, the content management module for the local appliance may delete a prior version of the content. In one embodiment, the content management module for the local appliance may, when the received version of the content exceeds a predetermined limit of versions, delete a prior version of the content (such as, the oldest prior version) in response to receiving the received version. The content management module for the local appliance may store any suitable number of versions (such as, 1, 2, 3, 4, 5, 6, 7, 8, or more versions) for any suitable number of files from any suitable number of computing devices. Of course, the content management module for the local appliance need not store multiple versions and may, for example, delete any prior version of the content in response to receiving the received version. Further, the local appliance need not store the version of the content at any time; thus, the block 426 is optional.

As shown in FIG. 4C, at a block 428, the content management module for the local appliance may send the version of the content to a local computer. At a block 430, a content management module for the local computer may receive the version of the content and, at a block 432, may store the version of the content in a storage device associated with the local computer. In response to receiving the received version of the content, the content management module for the local computer may delete a prior version of the content. In one embodiment, the content management module for the local computer may, when the received version of the content exceeds a predetermined limit of versions, delete a prior version of the content (such as, the oldest prior version) in response to receiving the received version. The content management module for the local computer may store any suitable number of versions (such as, 1, 2, 3, 4, 5, 6, 7, 8, or more versions) for any suitable number of files from any suitable number of computing devices. Of course, the content management module for the local computer need not store multiple versions and may, for example, delete any prior version of the content in response to receiving the received version.

FIG. 4D is a block diagram of the networking environment 100 (FIGS. 1A and 1B) in which some or all aspects of the methods 200 (FIG. 2A) and 420 (FIG. 4C) may be performed. As shown in FIGS. 4B and 4D, the file “a” stored on the storage device 140 (FIG. 4B) may be modified to another version—file “a1” stored on the storage device 140 (FIG. 4D). As shown in FIGS. 1A and 4D, the content management module 130 for the desktop 102 may send a copy of the file “a1” to the appliance 106. The content management module 122 for the appliance 106 may receive the copy of the file “a1,” may store the copy of the file “a1” in the storage device 150, and may send the copy of the file “a1” to the laptop 104. The content management module 132 for the laptop 104 may receive the copy of the file “a1” and may store the copy of the file “a1” in the storage device 142.

Remote Appliance Content Backup

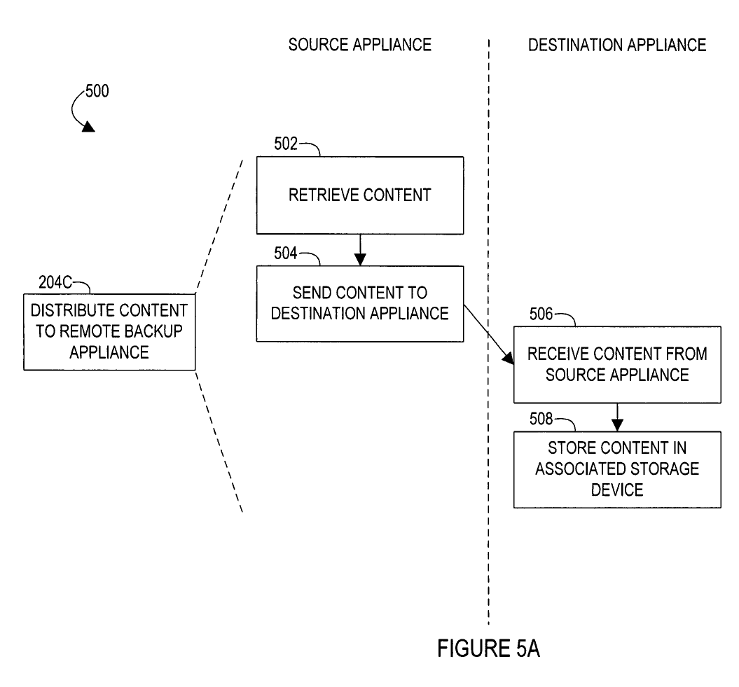

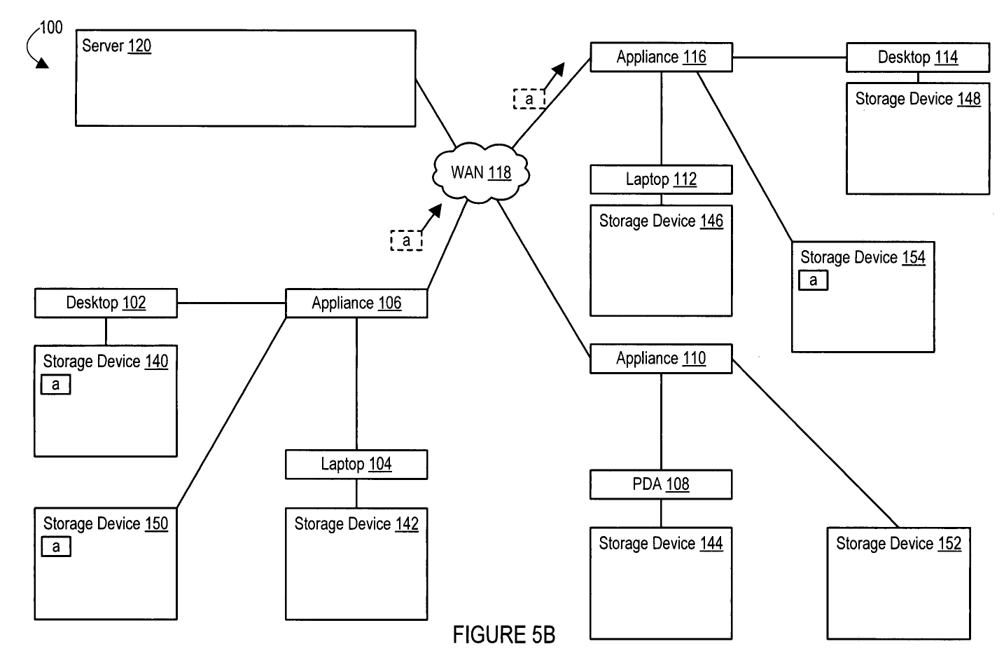

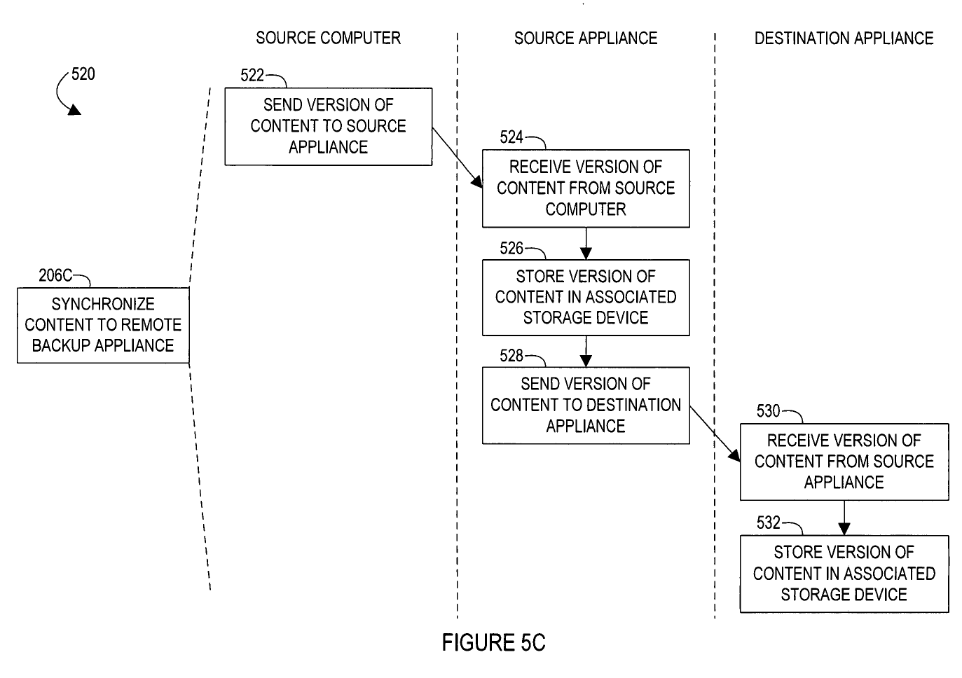

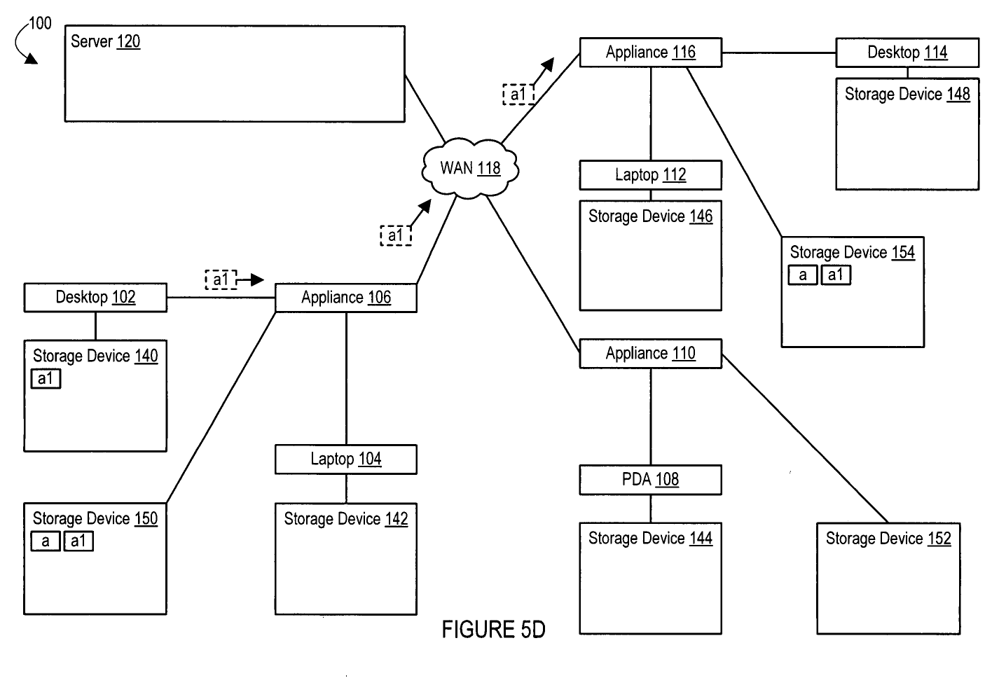

FIG. 5A is a flowchart illustrating an exemplary method 500 that may be performed using any suitable system, such as, the networking environment 100 shown in FIGS. 1A and 1B. In one embodiment, a content management system may perform some or all of the method 500. Of course, the method 500 may be performed by any other suitable system and in any other suitable environment.

In one embodiment, the block 204 (FIG. 2A) may comprise a block 204C (FIG. 5A) in which the content management system may distribute a copy of content to a remote appliance for backup purposes or the like. As shown in FIG. 5A, the block 204C may comprise one or more blocks. At a block 502, a content management module for a local appliance may retrieve a copy of the content from a suitable resource (such as, a storage device associated with the appliance, a content management module for a source computer, or the like). At a block 504, the content management module for the local appliance may send the copy of the content to a remote appliance. At a block 506, a content management module for the remote appliance may receive the copy of the content and, at a block 508, may store the copy of the content in a storage device associated with the remote appliance.

FIG. 5B is a block diagram of the networking environment 100 (FIGS. 1A and 1B) in which some or all aspects of the methods 200 (FIG. 2A) and 500 (FIG. 5A) may be performed. As shown in FIG. 5B, a file “a” may be stored on the storage device 140 of the desktop 102, may be stored on the storage device 150 of the appliance 106, or both. As shown in FIGS. 1A and 5B, the content management module 122 for the appliance 106 may retrieve a copy of the file “a.” The content management module 122 may retrieve a copy of the file “a” from the storage device 150. To retrieve a copy of the file “a,” the content management module 122 may request a copy of the file “a” from the content management module 130 for the desktop 102, which may retrieve a copy of the file “a” from the storage device 140 and send that copy to the content management module 122. The content management module 122 may retrieve a copy of the file “a” in any other suitable manner. The content management module 122 may send a copy of the file “a” to the appliance 116. The content management module 126 for the appliance 116 may receive the copy of the file “a” and may store the copy of the file “a” in the storage device 154

Synchronization of Remote Appliance Content Backup

FIG. 5C is a flowchart illustrating an exemplary method 520 that may be performed using any suitable system, such as, the networking environment 100 shown in FIGS. 1A and 1B. In one embodiment, a content management system may perform some or all of the method 520. Of course, the method 520 may be performed by any other suitable system and in any other suitable environment.

In one embodiment, the block 206 (FIG. 2A) may comprise a block 206C (FIG. 5C) in which the content management system may synchronize content to a remote appliance. As shown in FIG. 5C, the block 206C may comprise one or more blocks. At a block 522, a content management module for the source computer may send a version of the content to a local appliance. At a block 524, a content management module for the local appliance may receive the version of the content and, at a block 526, may store the version of the content in a storage device associated with the local appliance. In response to receiving the received version of the content, the content management module for the local appliance may delete a prior version of the content. In one embodiment, the content management module for the local appliance may, when the received version of the content exceeds a predetermined limit of versions, delete a prior version of the content (such as, the oldest prior version) in response to receiving the received version. The content management module for the local appliance may store any suitable number of versions (such as, 1, 2, 3, 4, 5, 6, 7, 8, or more versions) for any suitable number of files from any suitable number of computing devices. Of course, the contact management module of the local appliance need not store multiple versions and may, for example, delete any prior version of the content in response to receiving the received version. Further, the local appliance need not store the version of the content at any time; thus, the block 526 is optional.

As shown in FIG. 5C, at a block 528, the content management module for the local appliance may send the version of the content to a remote appliance. At a block 530, a content management module for the remote appliance may receive the version of the content and, at a block 532, may store the version of the content in a storage device associated with the remote appliance. In response to receiving the received version of the content, the content management module for the remote appliance may delete a prior version of the content. In one embodiment, the content management module for the remote appliance may, when the received version of the content exceeds a predetermined limit of versions, delete a prior version of the content (such as, the oldest prior version) in response to receiving the received version. The content management module for the remote appliance may store any suitable number of versions (such as, 1, 2, 3, 4, 5, 6, 7, 8, or more versions) for any suitable number of files from any suitable number of computing devices. Of course, the contact management module for the remote appliance need not store multiple versions and may, for example, delete any prior version of the content in response to receiving the received version.

FIG. 5D is a block diagram of the networking environment 100 (FIGS. 1A and 1B) in which some or all aspects of the methods 200 (FIG. 2A) and 520 (FIG. 5D) may be performed. As shown in FIGS. 5B and 5D, the file “a” stored on the storage device 140 (FIG. 5B) may be modified to another version—file “a1” stored on the storage device 140 (FIG. 5D). As shown in FIGS. 1A and 5D, the content management module 130 for the desktop 102 may send a copy of the file “a1” to the appliance 106. The content management module 122 for the appliance 106 may receive the copy of the file “a1” and may store the copy of the file “a1” in the storage device 150. The content management module 122 may send copy of the file “a1” to the appliance 116. The content management module 126 for the appliance 116 may receive copy of the file “a1” and may store the copy of the file “a1” in the storage device 154.

Remote Computing Device Content Backup

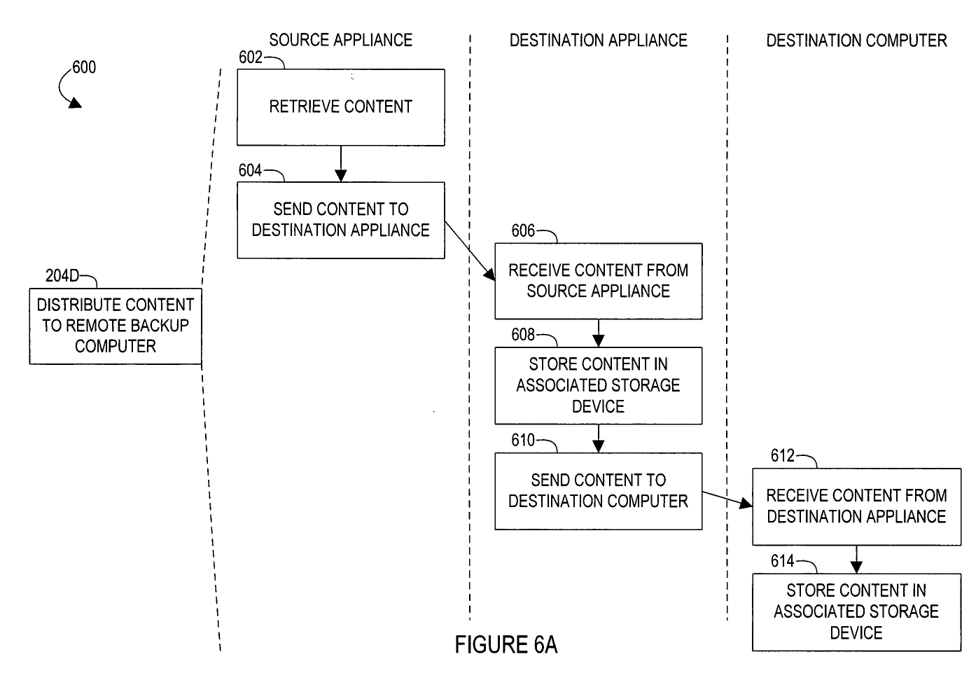

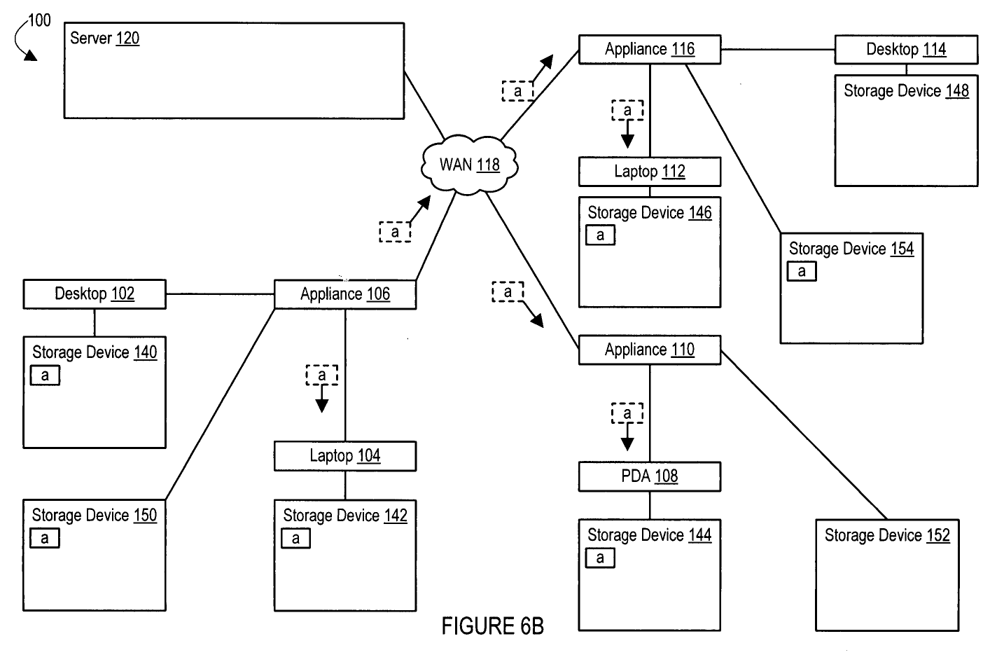

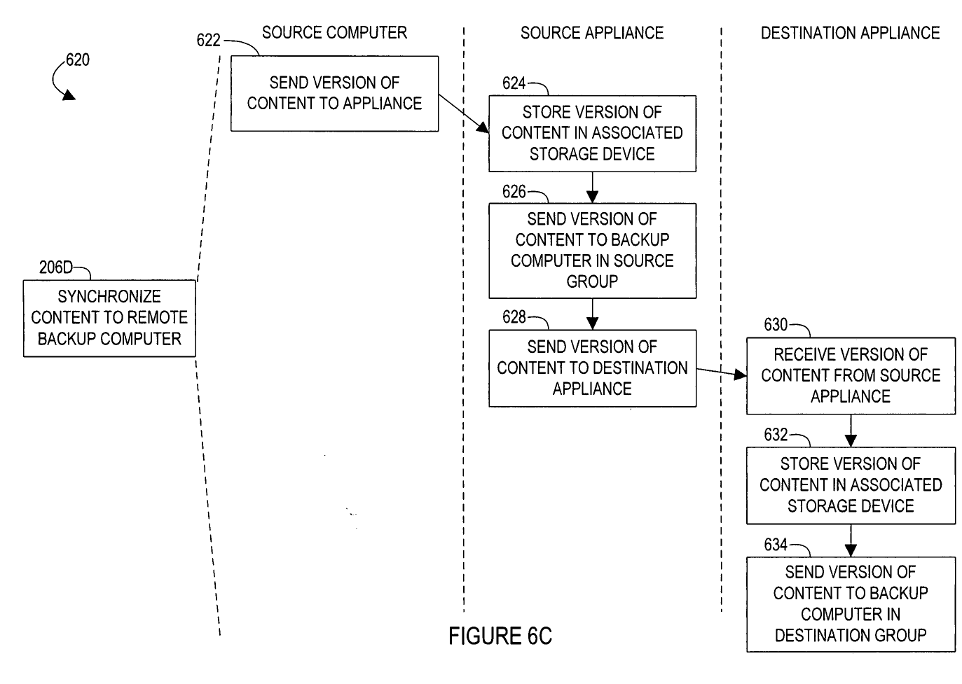

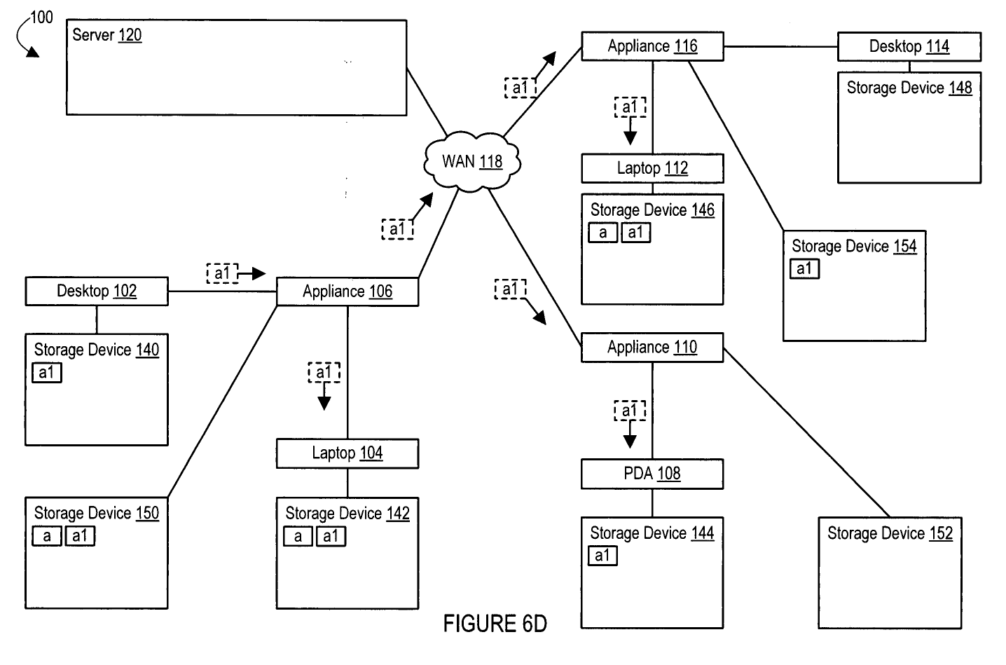

FIG. 6A is a flowchart illustrating an exemplary method 600 that may be performed using any suitable system, such as, the networking environment 100 shown in FIGS. 1A and 1B. In one embodiment, a content management system may perform some or all of the method 600. Of course, the method 600 may be performed by any other suitable system and in any other suitable environment.

In one embodiment, the block 204 (FIG. 2A) may comprise a block 204D (FIG. 6A) in which the content management system may distribute a copy of content to a remote computing device (such as, a remote computer) for backup purposes or the like. As shown in FIG. 6A, the block 204D may comprise one or more blocks. At a block 602, a content management module for a local appliance may retrieve a copy of the content from a suitable resource (such as, a storage device associated with the appliance, a content management module for a source computer, or the like). At a block 604, the content management module for the local appliance may send the copy of the content to a remote appliance. At a block 606, a content management module for the remote appliance may receive the copy of the content and, at a block 608, may optionally store the copy of the content in a storage device associated with the remote appliance. At a block 610, the content management module for the remote appliance may send the copy of the content to the remote computer. At a block 612, a content management module for the remote computer may receive the copy of the content and, at a block 614, may store the copy of the content in a storage device associated with the remote computer.

FIG. 6B is a block diagram of the networking environment 100 (FIGS. 1A and 1B) in which some or all aspects of the methods 200 (FIG. 2A) and 600 (FIG. 6A) may be performed. As shown in FIG. 6B, a file “a” may be stored on the storage device 140 of the desktop 102, may be stored on the storage device 150 of the appliance 106, or both. As shown in FIGS. 1A and 6B, the content management module 122 for the appliance 106 may retrieve a copy of the file “a.” The content management module 122 may retrieve a copy of the file “a” from the storage device 150. To retrieve a copy of the file “a,” the content management module 122 may request a copy of the file “a” from the content management module 130 for the desktop 102, which may retrieve a copy of the file “a” from the storage device 140 and send that copy to the content management module 122. The content management module 122 may retrieve a copy of the file “a” in any other suitable manner.

As shown in FIG. 6B, the content management module 122 may send a copy of the file “a” to the laptop 104. The content management module 132 for the laptop 104 may receive the copy of the file “a” and may store the copy of the file “a” in the storage device 142.

As shown in FIG. 6B, the content management module 122 may send a copy of the file “a” to the appliance 116. The content management module 126 for the appliance 116 may receive the copy of the file “a,” may store the copy of the file “a” in the storage device 154, and may send the copy of the file “a” to the laptop 112. The content management module 136 for the laptop 112 may receive the copy of the file “a” and may store the copy of the file “a” in the storage device 146.

As shown in FIG. 6B, the content management module 122 may send a copy of the file “a” to the appliance 110. The content management module 124 for the appliance 110 may receive the copy of the file “a” and may send the copy of the file “a” to the PDA 108. The content management module 134 for the PDA 108 may receive the copy of the file “a” and may store the copy of the file “a” in the storage device 144.

Synchronization of Remote Computing Device Content Backup

FIG. 6C is a flowchart illustrating an exemplary method 620 that may be performed using any suitable system, such as, the networking environment 100 shown in FIGS. 1A and 1B. In one embodiment, a content management system may perform some or all of the method 620. Of course, the method 620 may be performed by any other suitable system and in any other suitable environment.

In one embodiment, the block 206 (FIG. 2A) may comprise a block 206D (FIG. 6C) in which the content management system may synchronize content to a remote computing device (such as, a remote computer) for backup purposes or the like. As shown in FIG. 6C, the block 206D may comprise one or more blocks. At a block 622, a content management module for the source computer may send a version of the content to a local appliance. A content management module for the local appliance may receive the version of the content and, at a block 624, may store the version of the content in a storage device associated with the local appliance. In response to receiving the received version of the content, the content management module for the local appliance may delete a prior version of the content. In one embodiment, the content management module for the local appliance may, when the received version of the content exceeds a predetermined limit of versions, delete a prior version of the content (such as, the oldest prior version) in response to receiving the received version. The content management module for the local appliance may store any suitable number of versions (such as, 1, 2, 3, 4, 5, 6, 7, 8, or more versions) for any suitable number of files from any suitable number of computing devices. Of course, the contact management module for the local appliance need not store multiple versions and may, for example, delete any prior version of the content in response to receiving the received version. Further, the local appliance need not store the version of the content at any time; thus, the block 624 is optional.

As shown in FIG. 6C, at a block 626, the content management module for the local appliance may optionally send the version of the content to one or more local computing devices (such as, local computers) for backup purposes or the like. In response to receiving the received version of the content, a content management module for the local computer may store the received version of the content in a storage device associated with the local computer. In one embodiment, the content management module for the local computer may, when the received version of the content exceeds a predetermined limit of versions, delete a prior version of the content (such as, the oldest prior version) in response to receiving the received version. The content management module for the local computer may store any suitable number of versions (such as, 1, 2, 3, 4, 5, 6, 7, 8, or more versions) for any suitable number of files from any suitable number of computing devices. Of course, the content management module for the local computer need not store multiple versions and may, for example, delete any prior version of the content in response to receiving the received version. Further, the local computer need not store any content for backup purposes; thus, the block 626 is optional.

As shown in FIG. 6C, at a block 628, the content management module for the local appliance may send the version of the content to a remote appliance. At a block 630, a content management module for the remote appliance may receive the version of the content and, at a block 632, may store the version of the content in a storage device associated with the remote appliance. In response to receiving the received version of the content, the content management module for the remote appliance may delete a prior version of the content. In one embodiment, the content management module for the remote appliance may, when the received version of the content exceeds a predetermined limit of versions, delete a prior version of the content (such as, the oldest prior version) in response to receiving the received version. The content management module for the remote appliance may store any suitable number of versions (such as, 1, 2, 3, 4, 5, 6, 7, 8, or more versions) for any suitable number of files from any suitable number of computing devices. Of course, the content management module for the remote appliance need not store multiple versions and may, for example, delete any prior version of the content in response to receiving the received version. Further, the remote appliance need not store any content for backup purposes; thus, the block 632 is optional.

As shown in FIG. 6C, at a block 634, the content management module for the remote appliance may send the version of the content to one or more remote computing devices (such as, remote computers). In response to receiving the received version of the content, a content management module for the remote computer may store the received version of the content in a storage device associated with the remote computer. In response to receiving the received version of the content, a content management module for the remote computer may delete a prior version of the content. In one embodiment, the content management module for the remote computer may, when the received version of the content exceeds a predetermined limit of versions, delete a prior version of the content (such as, the oldest prior version) in response to receiving the received version. The content management module for the remote computer may store any suitable number of versions (such as, 1, 2, 3, 4, 5, 6, 7, 8, or more versions) for any suitable number of files from any suitable number of computing devices. Of course, the content management module for the remote computer need not store multiple versions and may, for example, delete any prior version of the content in response to receiving the received version.

FIG. 6D is a block diagram of the networking environment 100 (FIGS. 1A and 1B) in which some or all aspects of the methods 200 (FIG. 2A) and 620 (FIG. 6C) may be performed. As shown in FIGS. 6B and 6D, the file “a” stored on the storage device 140 (FIG. 6B) may be modified to another version—file “a1” stored on the storage device 140 (FIG. 6D).

As shown in FIGS. 1A and 6D, the content management module 130 for the desktop 102 may send a copy of the file “a1” to the appliance 106. The content management module 122 for the appliance 106 may receive the copy of the file “a1” and may store the copy of the file “a1” in the storage device 150.

As shown in FIGS. 1A and 6D, the content management module 122 for the appliance 106 may send copy of the file “a1” to the laptop 104. The content management module 132 for the laptop 104 may receive copy of the file “a1” and may store the copy of the file “a1” in the storage device 142.

As shown in FIGS. 1A and 6D, the content management module 122 for the appliance 106 may send copy of the file “a1” to the appliance 116. The content management module 126 for the appliance 116 may receive the copy of the file “a1,” may store the copy of the file “a1” in the storage device 154, may delete the file “a” from the storage device 154, and may send the copy of the file “a1” to the laptop 112. The content management module 136 for the laptop 112 may receive the copy of the file “a1” and may store the copy of the file “a1” in the storage device 146.

As shown in FIGS. 1A and 6D, the content management module 122 for the appliance 106 may send copy of the file “a1” to the appliance 110. The content management module 124 for the appliance 110 may receive the copy of the file “a1” and may send the copy of the file “a1” to the PDA 108. The content management module 134 for the PDA 108 may receive the copy of the file “a1,” may store the copy of the file “a1” in the storage device 144, and may delete the file “a” from the storage device 144.

Content Subscription & Synchronization

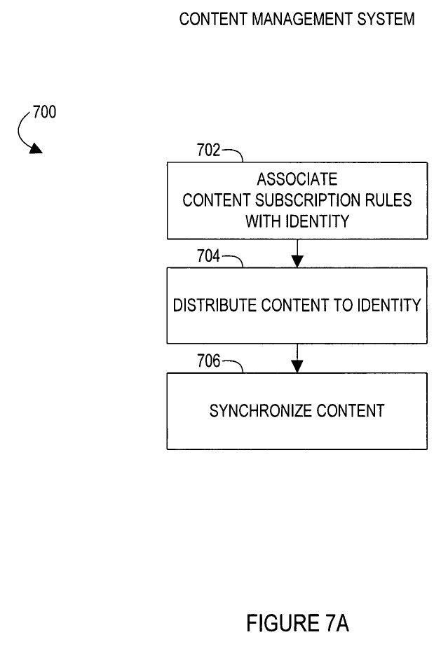

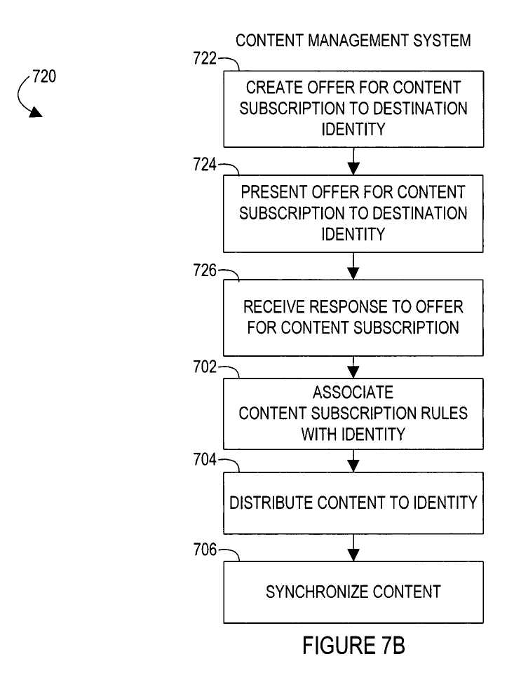

FIG. 7A is a flowchart illustrating an exemplary method 700 that may be performed using any suitable system, such as, the networking environment 100 shown in FIGS. 1A and 1B. In one embodiment, a content management system (such as, one or more the content management modules 122, 124, 126, 128, 130, 132, 134, 136, 138 shown in FIG. 1A) may perform some or all of the method 700. Of course, the method 700 may be performed by any other suitable system and in any other suitable environment.

As shown in FIG. 7A, at a block 702, the content management system may create one or more content-management rules. The contact management system may implement one or more content-management rules that may be identity-based, event-driven, or both. For example, in one embodiment, at the block 702, the content management rules may associate one or more content-subscription-related actions to be performed in response to one or more events. Exemplary events may include, for example, one or more of the following: content creation; content receipt; content modification; content deletion; content encryption; content download; content upload; content conversion; content corruption; virus detection; establishment of communication between a local device and the networking environment 100; establishment of communication between a remote device and the networking environment 100; passage of a predetermined period of time; a user logon to a device in the networking environment 100; a user logoff from a device in the networking environment 100; and any other suitable event. The content management rules may identify one or more content-subscription-related actions to be performed in response to one or more events, in response to metadata associated with content, in response to other suitable factors, or any suitable combination thereof. The contact management system may optionally comprise embodiments of the content management systems and methods there alike.

As shown in FIG. 7A, at a block 704, the content management system may distribute content to one or more identities, including one or more persons or discrete entities (such as, an application, a service, a module or the like) that may be capable of accessing or otherwise interacting with content. At a block 706, the content management system may synchronize content by, for example, providing a version of the content to an identity. The content management system may synchronize content in response to any suitable event, such as, for example, content modification. Thus, in one exemplary embodiment, in response to modification of the content on a storage device associated with a source computing device, the content management system may provide a modified version of the content to an identity.

FIG. 7B is a flowchart illustrating an exemplary method 720 that may be performed using any suitable system, such as, the networking environment 100 shown in FIGS. 1A and 1B. In one embodiment, a content management system may perform some or all of the method 720. Of course, the method 720 may be performed by any other suitable system and in any other suitable environment.

As shown in FIG. 7B, at a block 722, the content management system may create one or more offers for content subscription, which may be presented to a destination identity, a user of a destination identity, or the like. For example, the content management system may receive, via a first user interface, user input indicating a first user's desire to share content for collaboration purposes. The user may desire content stored one or more storage devices associated with a computing device, an appliance, or the like. At a block 724, the content management system may present the one or more offers for content subscription to a destination identity, a user of a destination identity, or the like. For example, the content management system may, via a second user interface, display (to a user of an appliance, a user of a computing device, or the like) the first user's desire to share content. At a block 226, the content management system may receive (from a destination identity, a user of a destination identity, or the like) one or more responses to the one or more requests for content backup. For example, the content management system may receive, via the second user interface, user input indicating that the user of an appliance, a user of a computing device, or the like accepts (or rejects) the offered content. In one embodiment, the second user interface may receive user input identifying a location, such as, a location identifier indicating a location where the offered content may be stored in a storage device associated with the user's appliance, computing device, or the like. Accordingly, content could be distributed to and/or synchronized to the location identified by the user input. As shown in FIG. 7B, if the user input indicates that the user of an appliance, a user of a computing device, or the like will accepts the offered content, the content management system may perform some or all of the method 700 (FIG. 7A), which may comprise the blocks 702, 704, and 706. Thus, advantageously, a first user may share content with a second user and that shared content may be synchronized in any suitable manner.

In one embodiment, a first user may offer to share content with a second user and may allow (or deny) the second user the ability to share content with other users. For example, the content management system may receive, via a user interface, user input indicating the first user's desire to share content with the second user and to deny the second user the ability to share (via the content management system) the content with other users.

Local Computing Device Content Subscription

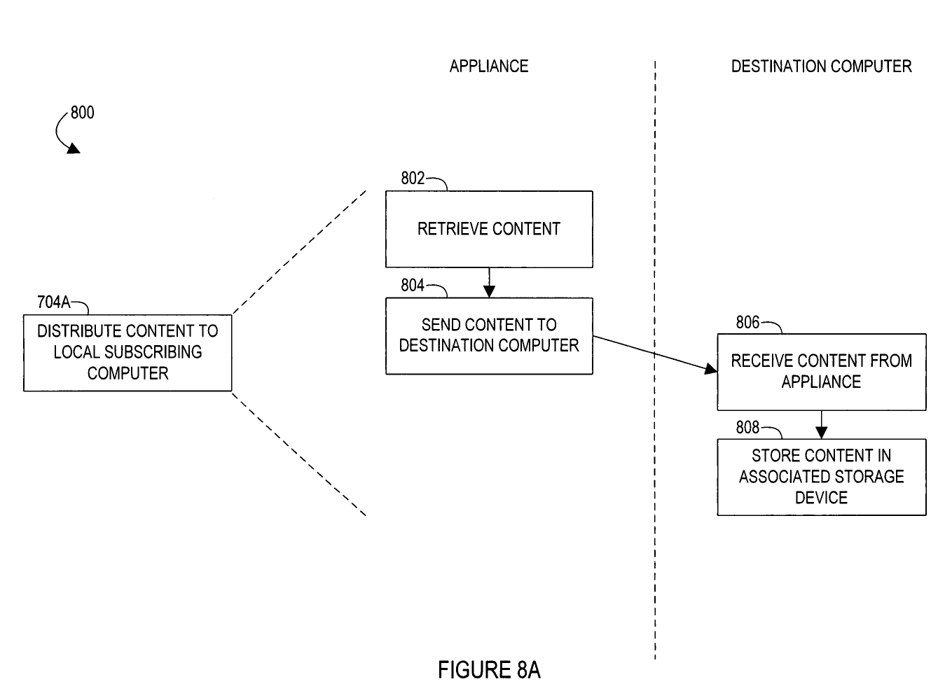

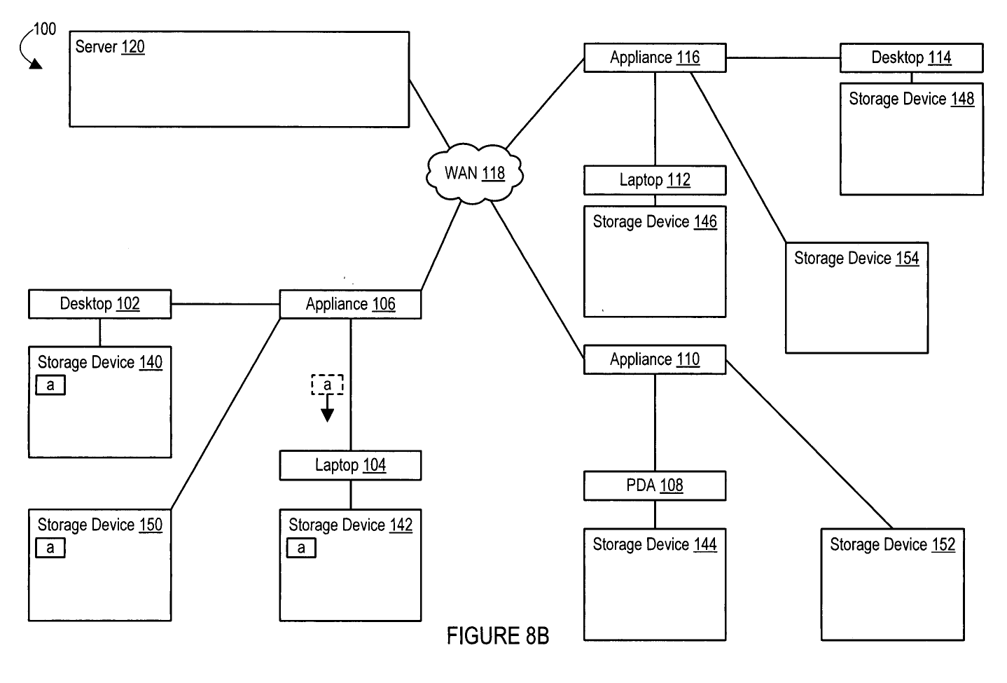

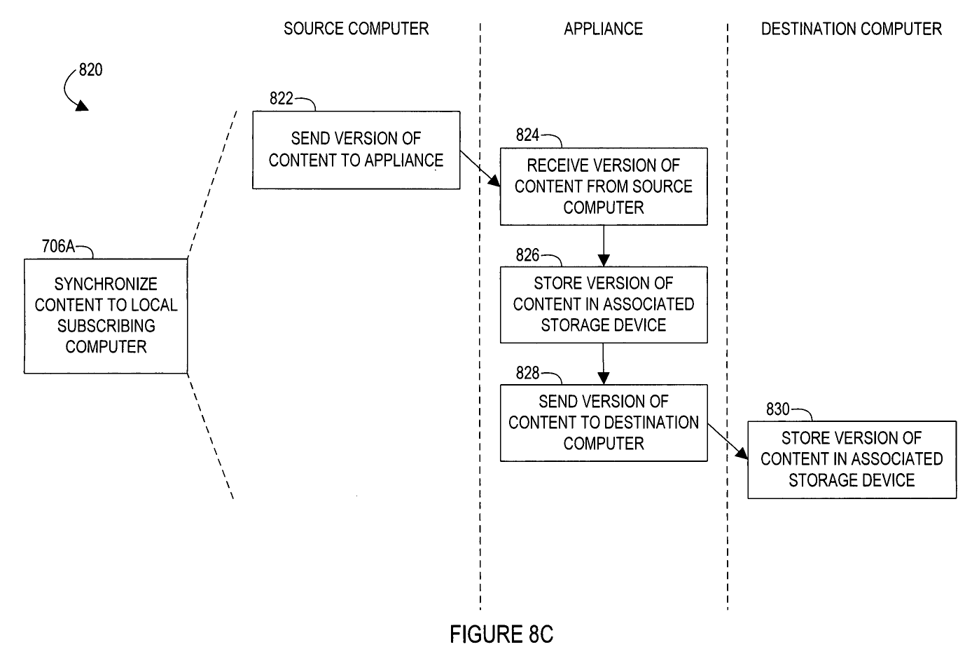

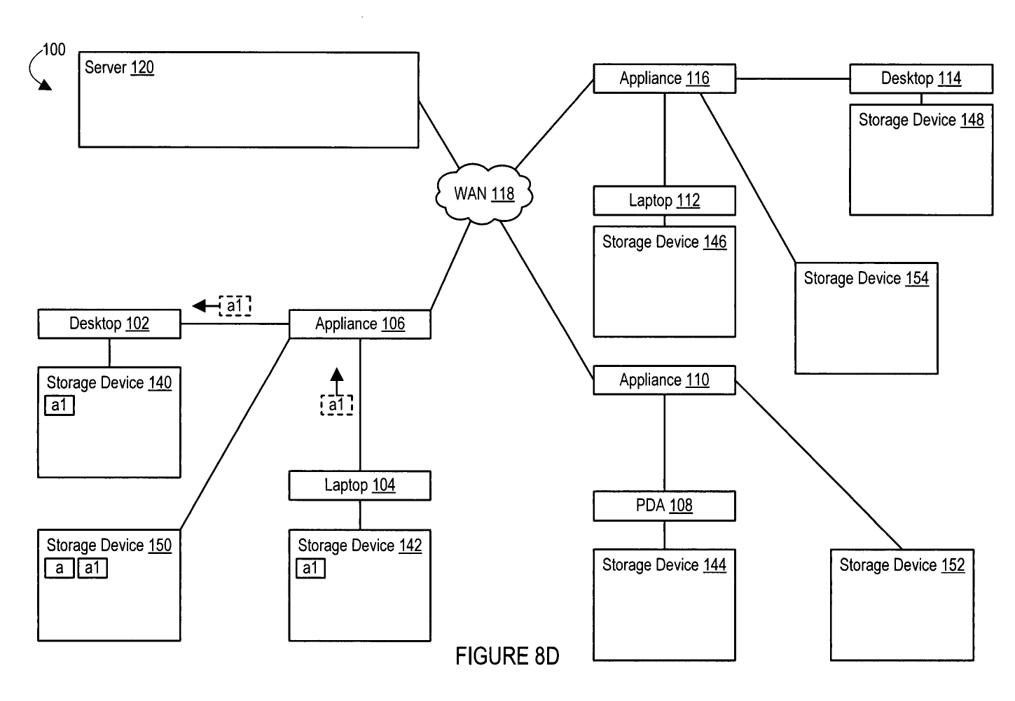

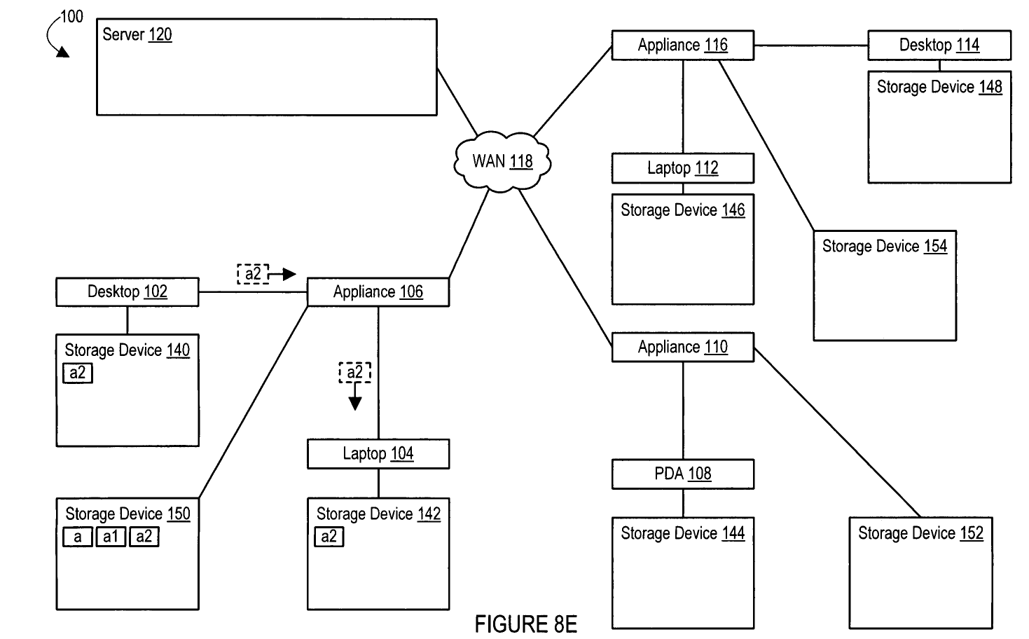

FIG. 8A is a flowchart illustrating an exemplary method 800 that may be performed using any suitable system, such as, the networking environment 100 shown in FIGS. 1A and 1B. In one embodiment, a content management system may perform some or all of the method 800. Of course, the method 800 may be performed by any other suitable system and in any other suitable environment.

In one embodiment, the block 704 (FIG. 7A) may comprise a block 704A (FIG. 8A) in which the content management system may distribute a copy of content to a local computing device (such as, a local computer) for collaboration purposes or the like. As shown in FIG. 8A, the block 704A may comprise one or more blocks. At a block 802, a content management module for an appliance may retrieve a copy of the content from a suitable resource (such as, a storage device associated with the appliance, a content management module for a source computer, or the like). At a block 804, the content management module for the appliance may send the copy of the content to a local computer. At a block 806, a content management module for the local computer may receive the copy of the content and, at a block 808, may store the copy of the content in a storage device associated with the local computer.

FIG. 8B is a block diagram of the networking environment 100 (FIGS. 1A and 1B) in which some or all aspects of the methods 700 (FIG. 7A) and 800 (FIG. 8A) may be performed. As shown in FIG. 8B, a file “a” may be stored on the storage device 140 of the desktop 102, may be stored on the storage device 150 of the appliance 106, or both.

As shown in FIGS. 1A and 8B, the content management module 122 for the appliance 106 may retrieve a copy of the file “a.” The content management module 122 may retrieve a copy of the file “a” from the storage device 150. To retrieve a copy of the file “a,” the content management module 122 may request a copy of the file “a” from the content management module 130 for the desktop 102, which may retrieve a copy of the file “a” from the storage device 140 and send that copy to the content management module 122. The content management module 122 may retrieve a copy of the file “a” in any other suitable manner.

As shown in FIGS. 1A and 8B, the content management module 122 may send a copy of the file “a” to the laptop 104. The content management module 132 for the laptop 104 may receive the copy of the file “a” and may store the copy of the file “a” in the storage device 142.

Synchronization of Local Computing Device Content Subscription

FIG. 8C is a flowchart illustrating an exemplary method 820 that may be performed using any suitable system, such as, the networking environment 100 shown in FIGS. 1A and 1B. In one embodiment, a content management system may perform some or all of the method 820. Of course, the method 820 may be performed by any other suitable system and in any other suitable environment.

In one embodiment, the block 706 (FIG. 7A) may comprise a block 706A (FIG. 8C) in which the content management system may synchronize content to a local computing device (such as, a local computer). As shown in FIG. 8C, the block 706A may comprise one or more blocks. At a block 822, a content management module for the source computer may send a version of the content to a local appliance. At a block 824, a content management module for the local appliance may receive the version of the content and, at a block 826, may store the version of the content in a storage device associated with the local appliance. In response to receiving the received version of the content, the content management module for the local appliance may delete a prior version of the content. In one embodiment, the content management module for the local appliance may, when the received version of the content exceeds a predetermined limit of versions, delete a prior version of the content (such as, the oldest prior version) in response to receiving the received version. The content management module for the local appliance may store any suitable number of versions (such as, 1, 2, 3, 4, 5, 6, 7, 8, or more versions) for any suitable number of files from any suitable number of computing devices. Of course, the content management module for the local appliance need not store multiple versions and may, for example, delete any prior version of the content in response to receiving the received version. Further, the local appliance need not store the version of the content at any time; thus, the block 826 is optional.

As shown in FIG. 8C, at a block 828, the content management module for the local appliance may send the version of the content to a local computer. A content management module for the local computer may receive the version of the content. In response to receiving the received version of the content, at a block 830, the content management module for the local computer may store the version of the content in a storage device associated with the local computer and may overwrite (or otherwise delete) any prior version of the content on the storage device associated with the local computer.

FIGS. 8D and 8E are block diagrams of the networking environment 100 (FIGS. 1A and 1B) in which some or all aspects of the methods 700 (FIG. 7A) and 820 (FIG. 8C) may be performed. As shown in FIGS. 8B and 8D, the file “a” stored on the storage device 142 (FIG. 8B) may be modified to another version—file “a1” stored on the storage device 142 (FIG. 8D). As shown in FIGS. 1A and 8D, the content management module 132 for the laptop 104 may send a copy of the file “a1” to the appliance 106. The content management module 122 for the appliance 106 may receive the copy of the file “a1” and may store the copy of the file “a1” in the storage device 150. The content management module 122 may send copy of the file “a1” to the desktop 102. The content management module 130 for the desktop 102 may receive copy of the file “a1” and may store the copy of the file “a1” in the storage device 140.

As shown in FIGS. 8D and 8E, the file “a1” stored on the storage device 140 (FIG. 8D) may be modified to another version—file “a2” stored on the storage device 140 (FIG. 8E). As shown in FIGS. 1A and 8E, the content management module 130 for the desktop 102 may send a copy of the file “a2” to the appliance 106. The content may store the copy of the file “a2” in the storage device 150. The content management module 122 may send copy of the file “a2” to the laptop 104. The content management module 132 for the laptop 104 may receive copy of the file “a2” and may store the copy of the file “a2” in the storage device 142.

Remote Computing Device Content Subscription

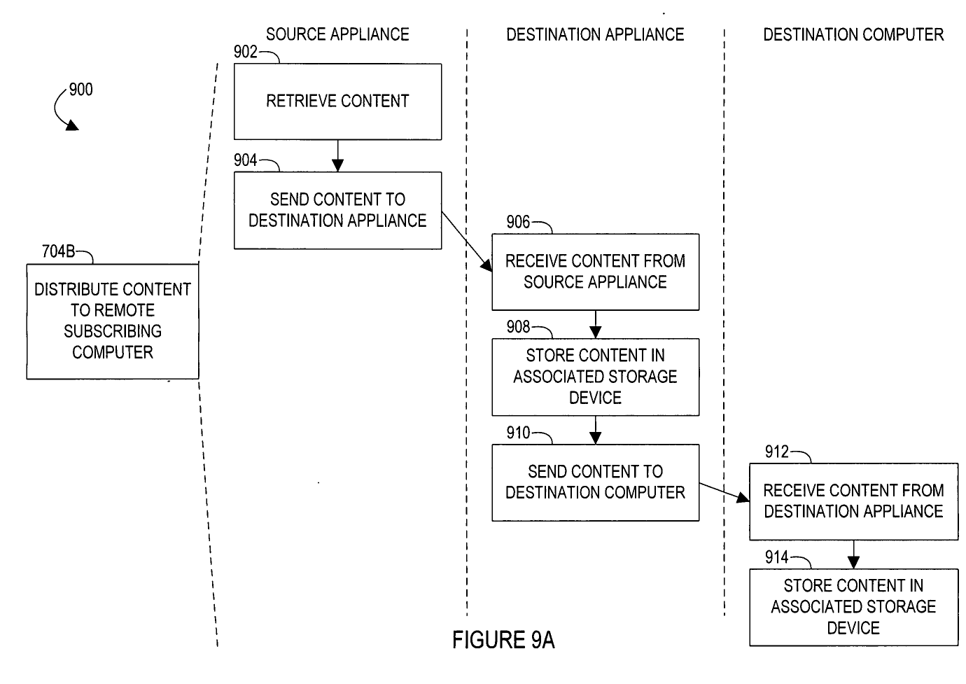

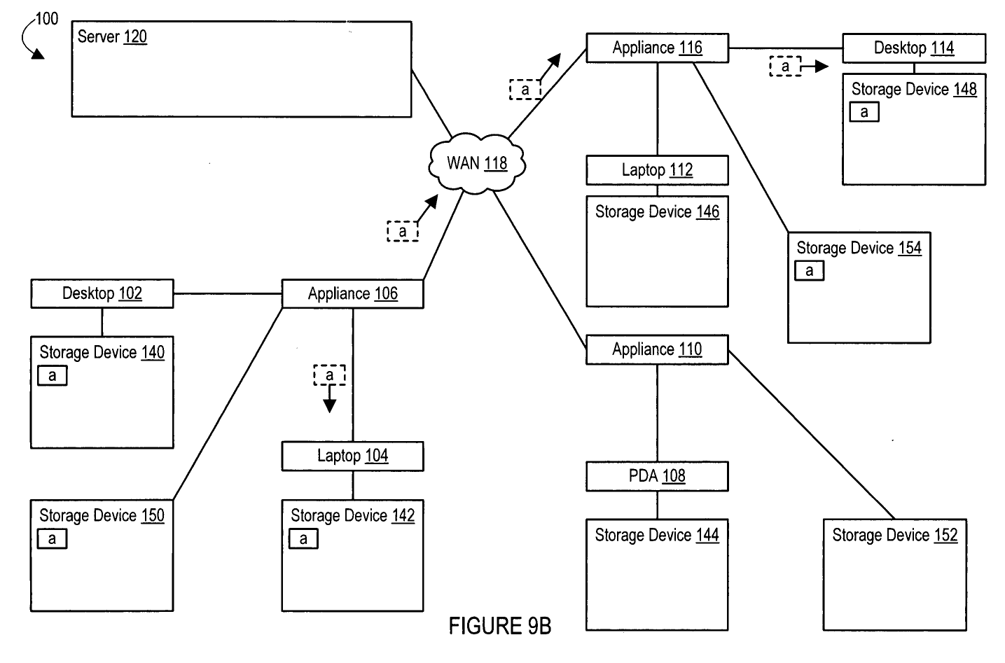

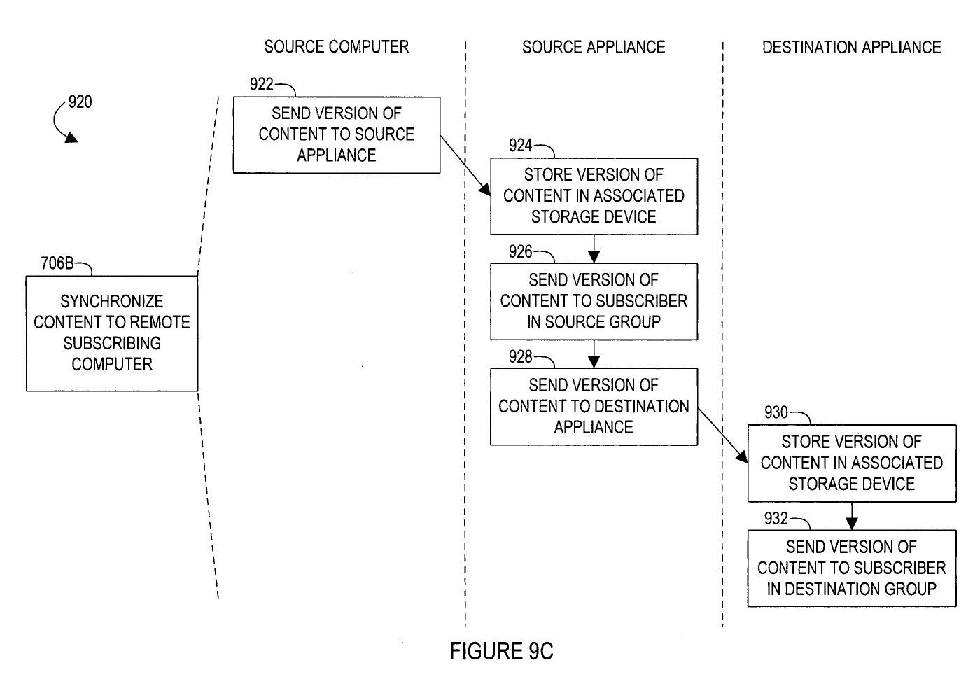

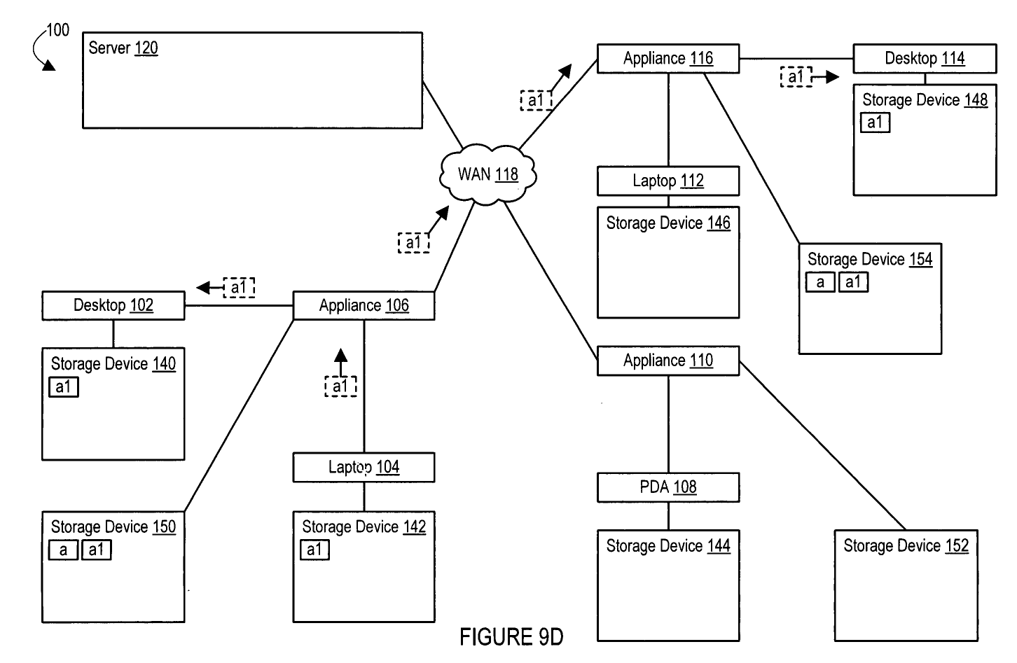

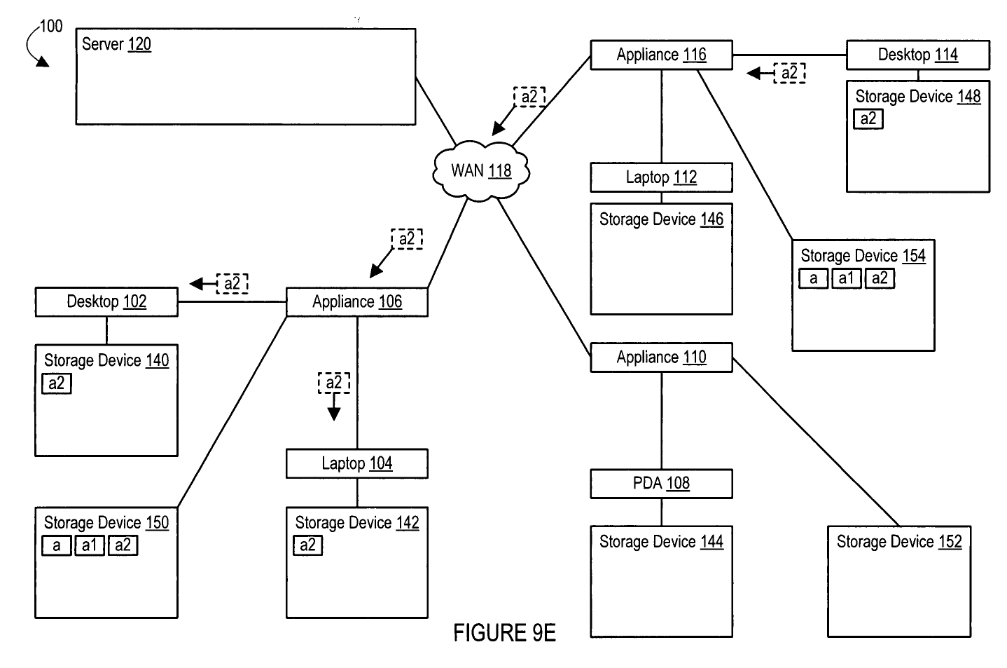

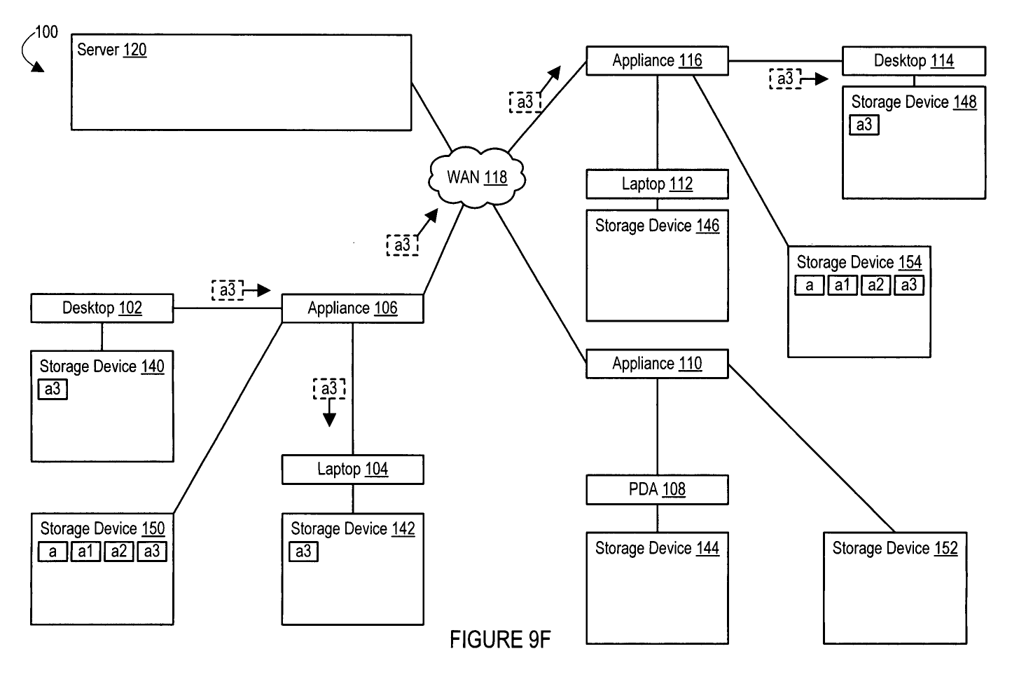

FIG. 9A is a flowchart illustrating an exemplary method 900 that may be performed using any suitable system, such as, the networking environment 100 shown in FIGS. 1A and 1B. In one embodiment, a content management system may perform some or all of the method 900. Of course, the method 900 may be performed by any other suitable system and in any other suitable environment.

In one embodiment, the block 704 (FIG. 7A) may comprise a block 704B (FIG. 9A) in which the content management system may distribute a copy of content to a remote computing device (such as, a remote computer) for collaboration purposes or the like. As shown in FIG. 9A, the block 704B may comprise one or more blocks. At a block 902, a content management module for a local appliance may retrieve a copy of the content from a suitable resource (such as, a storage device associated with the appliance, a content management module for a source computer, or the like). At a block 904, the content management module for the local appliance may send the copy of the content to a remote appliance. At a block 906, a content management module for the remote appliance may receive the copy of the content and, at a block 908, may optionally store the copy of the content in a storage device associated with the remote appliance. At a block 910, the content management module for the remote appliance may send the copy of the content to the remote computer. At a block 912, a content management module for the remote computer may receive the copy of the content and, at a block 914, may store the copy of the content in a storage device associated with the remote computer.

FIG. 9B is a block diagram of the networking environment 100 (FIGS. 1A and 1B) in which some or all aspects of the methods 700 (FIG. 7A) and 900 (FIG. 9A) may be performed. As shown in FIG. 9B, a file “a” may be stored on the storage device 140 of the desktop 102, may be stored on the storage device 150 of the appliance 106, or both. As shown in FIGS. 1A and 9B, the content management module 122 for the appliance 106 may retrieve a copy of the file “a.” The content management module 122 may retrieve a copy of the file “a” from the storage device 150. To retrieve a copy of the file “a,” the content management module 122 may request a copy of the file “a” from the content management module 130 for the desktop 102, which may retrieve a copy of the file “a” from the storage device 140 and send that copy to the content management module 122. The content management module 122 may retrieve a copy of the file “a” in any other suitable manner.

As shown in FIG. 9B, the content management module 122 may send a copy of the file “a” to the laptop 104. The content management module 132 for the laptop 104 may receive the copy of the file “a” and may store the copy of the file “a” in the storage device 142.

As shown in FIG. 9B, the content management module 122 may send a copy of the file “a” to the appliance 116. The content management module 126 for the appliance 116 may receive the copy of the file “a,” may store the copy of the file “a” in the storage device 154, and may send the copy of the file “a” to the desktop 114. The content management module 138 for the desktop 114 may receive the copy of the file “a” and may store the copy of the file “a” in the storage device 148.

Synchronization of Remote Computing Device Content Subscription

FIG. 9C is a flowchart illustrating an exemplary method 920 that may be performed using any suitable system, such as, the networking environment 100 shown in FIGS. 1A and 1B. In one embodiment, a content management system may perform some or all of the method 920. Of course, the method 920 may be performed by any other suitable system and in any other suitable environment.

In one embodiment, the block 706 (FIG. 7A) may comprise a block 706B (FIG. 9C) in which the content management system may synchronize content to a remote computing device (such as, a remote computer) for collaboration purposes or the like. As shown in FIG. 9C, the block 706B may comprise one or more blocks. At a block 922, a content management module for the source computer may send a version of the content to a local appliance. A content management module for the local appliance may receive the version of the content and, at a block 924, may store the version of the content in a storage device associated with the local appliance. In response to receiving the received version of the content, the content management module for the local appliance may delete a prior version of the content. In one embodiment, the content management module for the local appliance may, when the received version of the content exceeds a predetermined limit of versions, delete a prior version of the content (such as, the oldest prior version) in response to receiving the received version. The content management module for the local appliance may store any suitable number of versions (such as, 1, 2, 3, 4, 5, 6, 7, 8, or more versions) for any suitable number of files from any suitable number of computing devices. Of course, the contact management module for the local appliance need not store multiple versions and may, for example, delete any prior version of the content in response to receiving the received version. Further, the local appliance need not store the version of the content at any time; thus, the block 924 is optional.

As shown in FIG. 9C, at a block 926, the content management module for the local appliance may optionally send the version of the content to one or more local computing devices (such as, local computers) for collaboration purposes or the like. In response to receiving the received version of the content, a content management module for the local computer may store the received version of the content in a storage device associated with the local computer and may overwrite (or otherwise delete) any prior version of the content on the storage device associated with the local computer.

As shown in FIG. 9C, at a block 928, the content management module for the local appliance may send the version of the content to a remote appliance. A content management module for the remote appliance may receive the version of the content and, at a block 930, may store the version of the content in a storage device associated with the remote appliance. In response to receiving the received version of the content, the content management module for the remote appliance may delete a prior version of the content. In one embodiment, the content management module for the remote appliance may, when the received version of the content exceeds a predetermined limit of versions, delete a prior version of the content (such as, the oldest prior version) in response to receiving the received version. The content management module for the remote appliance may store any suitable number of versions (such as, 1, 2, 3, 4, 5, 6, 7, 8, or more versions) for any suitable number of files from any suitable number of computing devices. Of course, the content management module for the remote appliance need not store multiple versions and may, for example, delete any prior version of the content in response to receiving the received version. Further, the remote appliance need not store any content for collaboration purposes; thus, the block 930 is optional.

As shown in FIG. 9C, at a block 932, the content management module for the remote appliance may send the version of the content to one or more remote computing devices (such as, remote computers). In response to receiving the received version of the content, a content management module for the remote computer may store the received version of the content in a storage device associated with the remote computer and overwrite (or otherwise delete) any prior version of the content on the storage device associated with the remote computer.

FIGS. 9D, 9E, and 9F are block diagrams of the networking environment 100 (FIGS. 1A and 1B) in which some or all aspects of the methods 700 (FIG. 7A) and 920 (FIG. 9C) may be performed. As shown in FIGS. 9B and 9D, the file “a” stored on the storage device 142 (FIG. 9B) may be modified to another version—file “a1” stored on the storage device 142 (FIG. 9D).

As shown in FIGS. 1A and 9D, the content management module 132 for the laptop 104 may send a copy of the file “a1” to the appliance 106. The content management module 122 for the appliance 106 may receive the copy of the file “a1” and may store the copy of the file “a1” in the storage device 150.

As shown in FIGS. 1A and 9D, the content management module 122 for the appliance 106 may send copy of the file “a1” to the desktop 102. The content management module 130 for the desktop 102 may receive copy of the file “a1,” may store the copy of the file “a1” in the storage device 140, and may delete the file “a” from the storage device 140.

As shown in FIGS. 1A and 9D, the content management module 122 for the appliance 106 may send copy of the file “a1” to the appliance 116. The content management module 126 for the appliance 116 may receive the copy of the file “a1,” may store the copy of the file “a1” in the storage device 154 and may send the copy of the file “a1” to the desktop 114. The content management module 138 for the desktop 114 may receive the copy of the file “a1,” may store the copy of the file “a1” in the storage device 148, and may delete the file “a” from the storage device 148.

As shown in FIGS. 9D and 9E, the file “a1” stored on the storage device 148 (FIG. 9D) may be modified to another version—file “a2” stored on the storage device 148 (FIG. 9E).

As shown in FIGS. 1A and 9E, the content management module 138 for the desktop 114 may send a copy of the file “a2” to the appliance 116. The content management module 126 for the appliance 116 may receive the copy of the file “a2” and may store the copy of the file “a2” in the storage device 154.

As shown in FIGS. 1A and 9E, the content management module 126 for the appliance 116 may send copy of the file “a2” to the appliance 106. The content management module 122 for the appliance 106 may receive the copy of the file “a2,” may store the copy of the file “a2” in the storage device 150, may send the copy of the file “a2” to the desktop 102, and may send the copy of the file “a2” to the laptop 104. The content management module 130 for the desktop 102 may receive the copy of the file “a2,” may store the copy of the file “a2” in the storage device 140, and may delete the file “a1” from the storage device 140. The content management module 132 for the laptop 104 may receive the copy of the file “a2,” may store the copy of the file “a2” in the storage device 140, and may delete the file “a1” from the storage device 140.

As shown in FIGS. 9E and 9F, the file “a2” stored on the storage device 140 (FIG. 9E) may be modified to another version—file “a3” stored on the storage device 140 (FIG. 9F).

As shown in FIGS. 1A and 9F, the content management module 130 for the desktop 102 may send a copy of the file “a3” to the appliance 106. The content management module 122 for the appliance 106 may receive the copy of the file “a3” and may store the copy of the file “a3” in the storage device 150.

As shown in FIGS. 1A and 9F, the content management module 122 for the appliance 106 may send copy of the file “a3” to the laptop 104. The content management module 132 for the laptop 104 may receive copy of the file “a3,” may store the copy of the file “a3” in the storage device 142, and may delete the file “a2” from the storage device 142.

As shown in FIGS. 1A and 9F, the content management module 122 for the appliance 106 may send copy of the file “a3” to the appliance 116. The content management module 126 for the appliance 116 may receive the copy of the file “a3,” may store the copy of the file “a3” in the storage device 154, and may send the copy of the file “a3” to the desktop 114. The content management module 138 for the desktop 114 may receive the copy of the file “a3,” may store the copy of the file “a3” in the storage device 148, and may delete the file “a2” from the storage device 148.

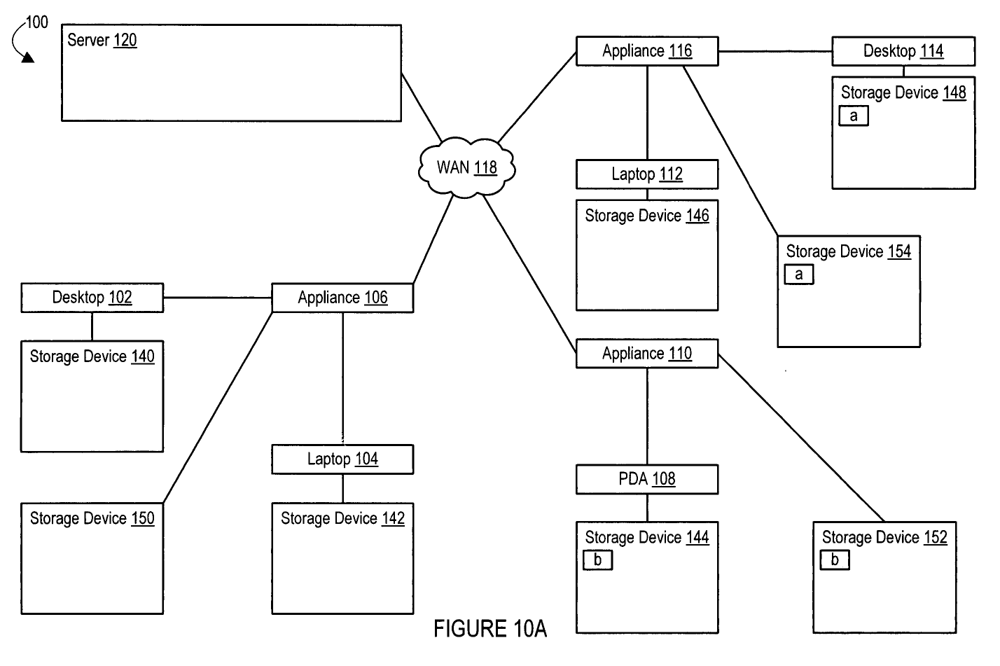

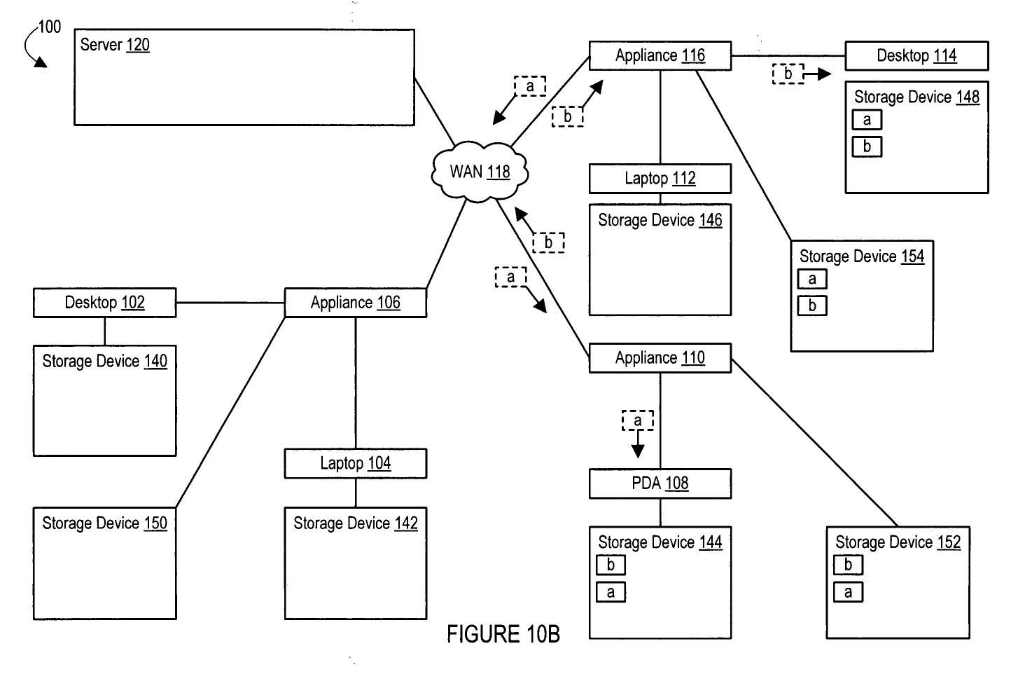

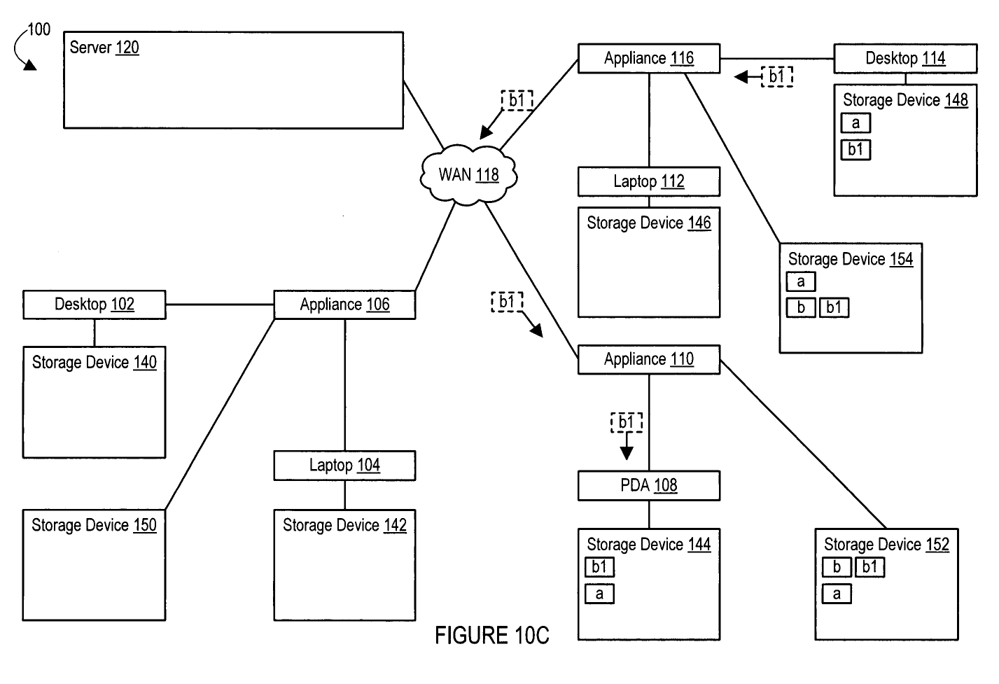

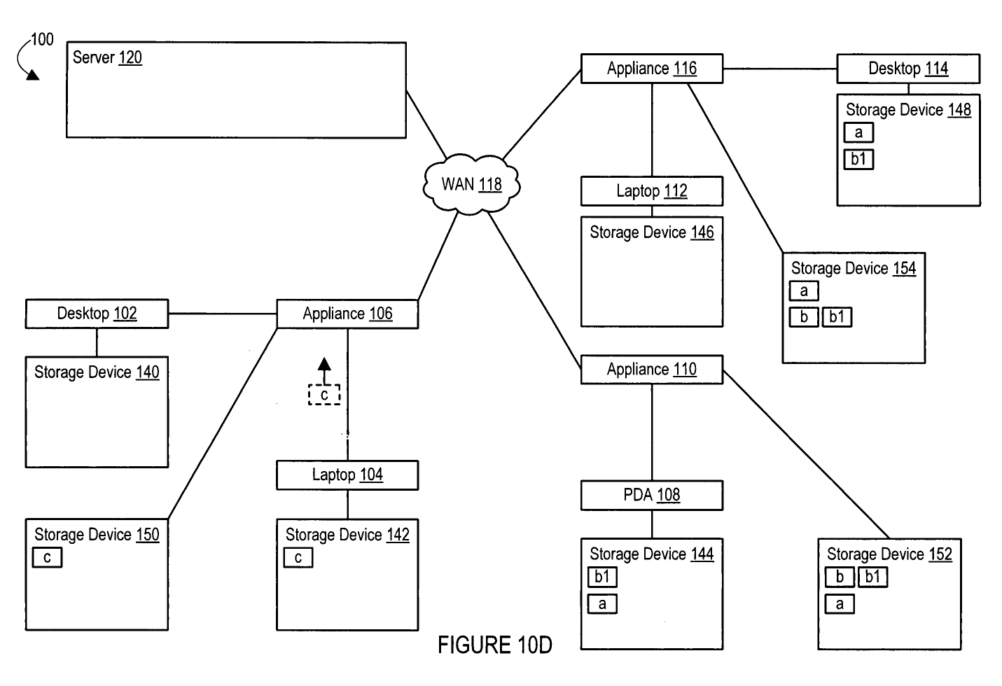

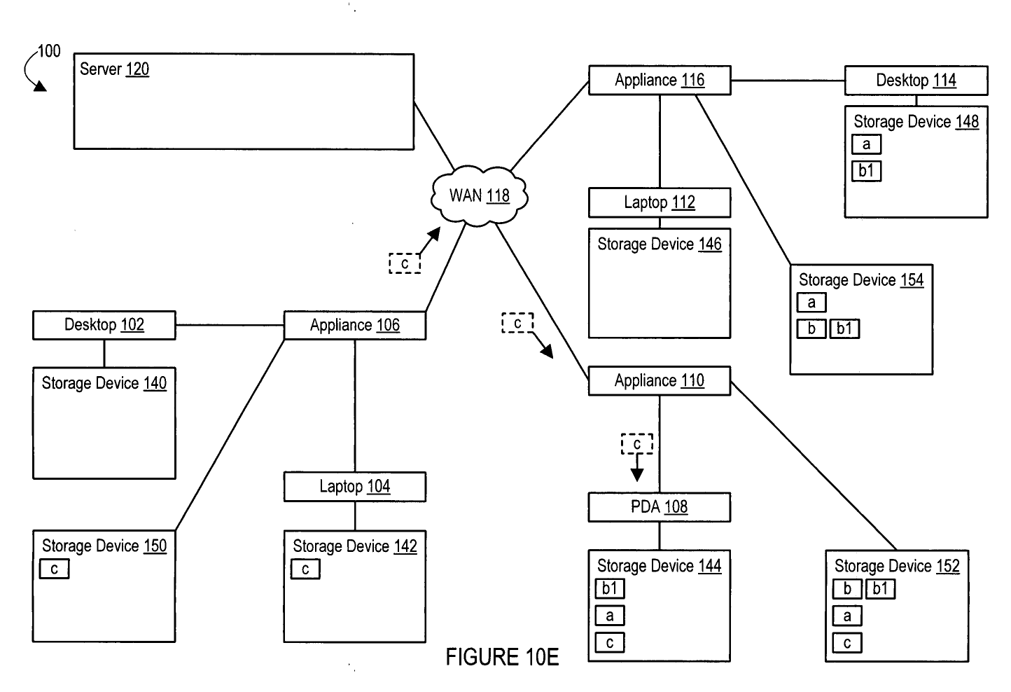

FIGS. 10A, 10B, 10C, 10D, and 10E are block diagrams of the networking environment 100 (FIGS. 1A and 1B) in which some or all aspects of the methods 700 (FIG. 7A), 900 (FIG. 9A), and 920 (FIG. 9C) may be performed.

As shown in FIG. 10A, a file “a” may be stored on the storage device 148 of the desktop 114, may be stored on the storage device 154 of the appliance 116, or both. Also, a file “b” may be stored on the storage device 144 of the PDA 108, may be stored on the storage device 152 of the appliance 110, or both.

As shown in FIGS. 1A and 10B, the content management module 126 for the appliance 116 may retrieve a copy of the file “a.” The content management module 126 may retrieve a copy of the file “a” from the storage device 154. To retrieve a copy of the file “a,” the content management module 126 may request a copy of the file “a” from the content management module 138 for the desktop 114, which may retrieve a copy of the file “a” from the storage device 148 and send that copy to the content management module 126. The content management module 126 may retrieve a copy of the file “a” in any other suitable manner.

As shown in FIG. 1A and FIG. 10B, the content management module 126 may send a copy of the file “a” to the appliance 110. The content management module 124 for the appliance 110 may receive the copy of the file “a,” may store the copy of the file “a” in the storage device 152, and may send the copy of the file “a” to the PDA 108. The content management module 134 for the PDA 108 may receive the copy of the file “a” and may store the copy of the file “a” in the storage device 144.

As shown in FIGS. 1A and 10B, the content management module 124 for the appliance 110 may retrieve a copy of the file “b.” The content management module 124 may retrieve a copy of the file “b” from the storage device 152. To retrieve a copy of the file “b,” the content management module 124 may request a copy of the file “b” from the content management module 134 for the PDA 108, which may retrieve a copy of the file “b” from the storage device 144 and send that copy to the content management module 124. The content management module 124 may retrieve a copy of the file “b” in any other suitable manner.

As shown in FIGS. 1A and 10B, the content management module 124 may send a copy of the file “b” to the appliance 116. The content management module 126 for the appliance 116 may receive the copy of the file “b,” may store the copy of the file “b” in the storage device 154, and may send the copy of the file “b” to the desktop 114. The content management module 138 for the desktop 114 may receive the copy of the file “b” and may store the copy of the file “b” in the storage device 148.

As shown in FIGS. 10B and 10C, the file “b” stored on the storage device 148 (FIG. 10B) may be modified to another version—file “b1” stored on the storage device 148 (FIG. 10C).

As shown in FIGS. 1A and 10C, the content management module 138 for the desktop 114 may send a copy of the file “b1” to the appliance 116. The content management module 126 for the appliance 116 may receive the copy of the file “b1” and may store the copy of the file “b1” in the storage device 154.

As shown in FIGS. 1A and 10C, the content management module 126 for the appliance 116 may send copy of the file “b1” to the appliance 110. The content management module 124 for the appliance 110 may receive the copy of the file “b1,” may store the copy of the file “b1” in the storage device 152 and may send the copy of the file “b1” to the PDA 108. The content management module 134 for the PDA 108 may receive the copy of the file “b1,” may store the copy of the file “b 1” in the storage device 144, and may delete the file “b” from the storage device 144.

As shown in FIGS. 1A and 10D, a file “c” may be stored on the storage device 142 of the laptop 104. The content management module 132 for the laptop 104 may send a copy of the file “c” to the appliance 106. The content management module 122 for the appliance 106 may receive the copy of the file “c” and may store the copy of the file “c” in the storage device 150.

As shown in FIGS. 1A and 10E, the content management module 122 for the appliance 106 may retrieve a copy of the file “c.” The content management module 122 may retrieve a copy of the file “c” from the storage device 150. To retrieve a copy of the file “c,” the content management module 122 may request a copy of the file “c” from the content management module 132 for the laptop 104, which may retrieve a copy of the file “c” from the storage device 142 and send that copy to the content management module 122. The content management module 122 may retrieve a copy of the file “c” in any other suitable manner.

As shown in FIGS. 1A and 1E, the content management module 122 may send a copy of the file “c” to the appliance 110. The content management module 124 for the appliance 110 may receive the copy of the file “c,” may store the copy of the file “c” in the storage device 152, and may send the copy of the file “c” to the PDA 108. The content management module 134 for the PDA 108 may receive the copy of the file “c” and may store the copy of the file “a” in the storage device 144.

Distribution and Synchronization of Content

In distributing and/or synchronizing content for backup purposes, for collaboration purposes or for any other suitable purpose, any computing device may optionally distribute different content to different sets of destination appliances, destination computing devices, and the like. For example, in one embodiment, a computing device may distribute a first set of content to a first set of one or more destination devices and distribute another set of content to another set of one or more destination devices. Likewise, any computing device may receive different content from different source appliances, source computing devices, and the like. For example, in one embodiment, a computing device may receive a first set of content from one source device and may receive a second set of content from another source device. Accordingly, because a computing device may distribute various content to—and may receive various content from—one or more other devices in a virtually unlimited number of configurations, the networking system 100 may be customized and scaled to meet the needs of many businesses and individuals.

Directly Distributing and Synchronizing Content

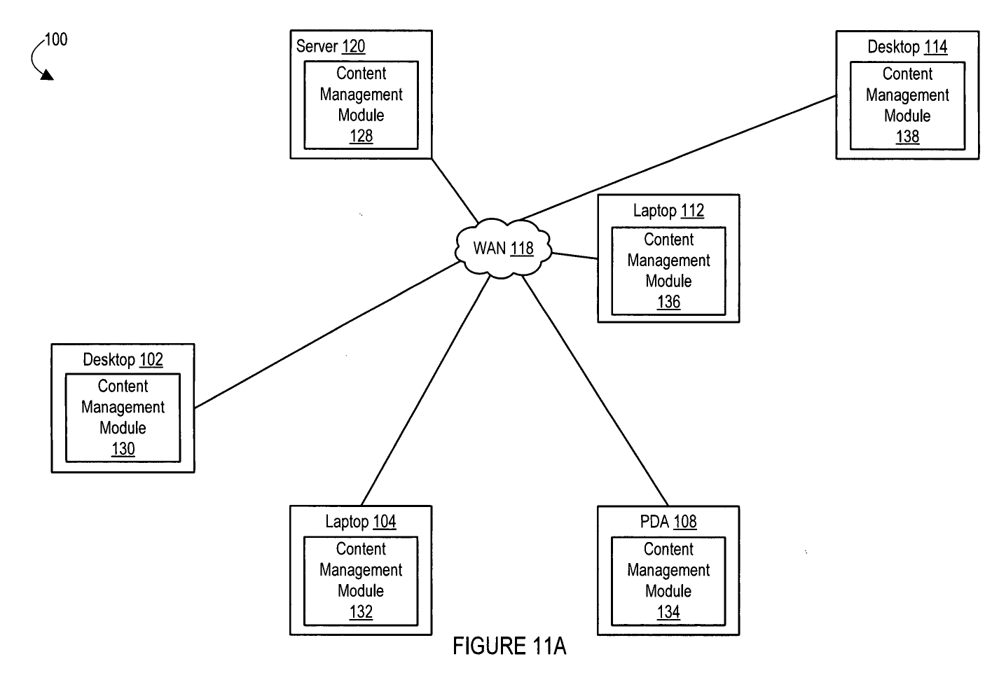

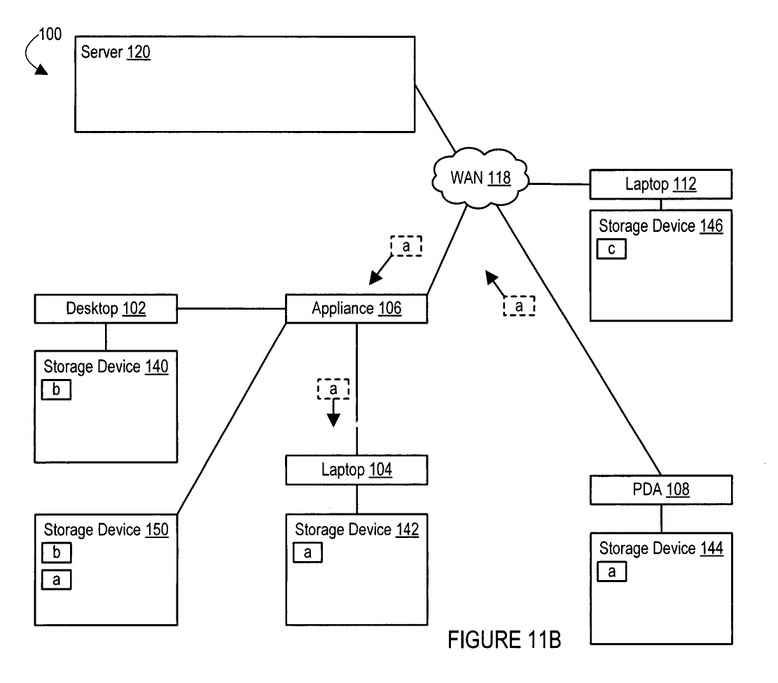

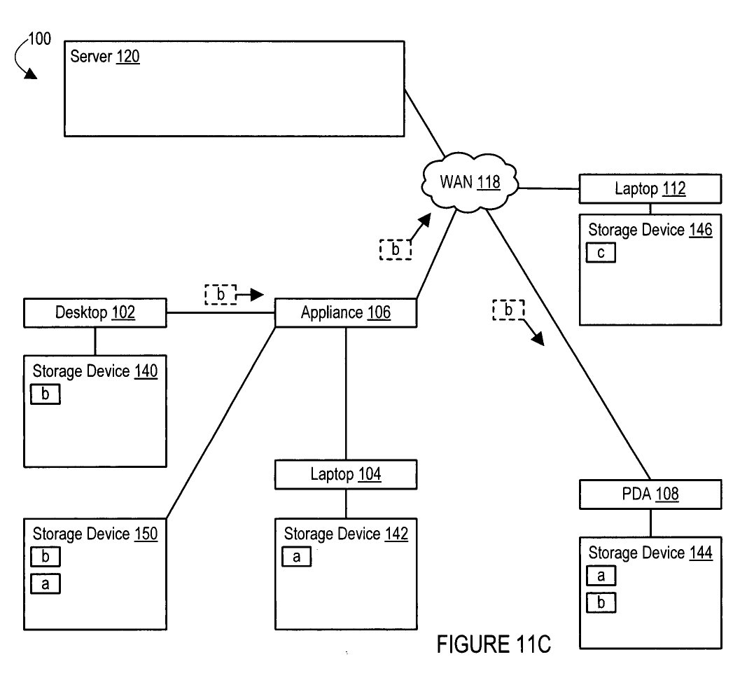

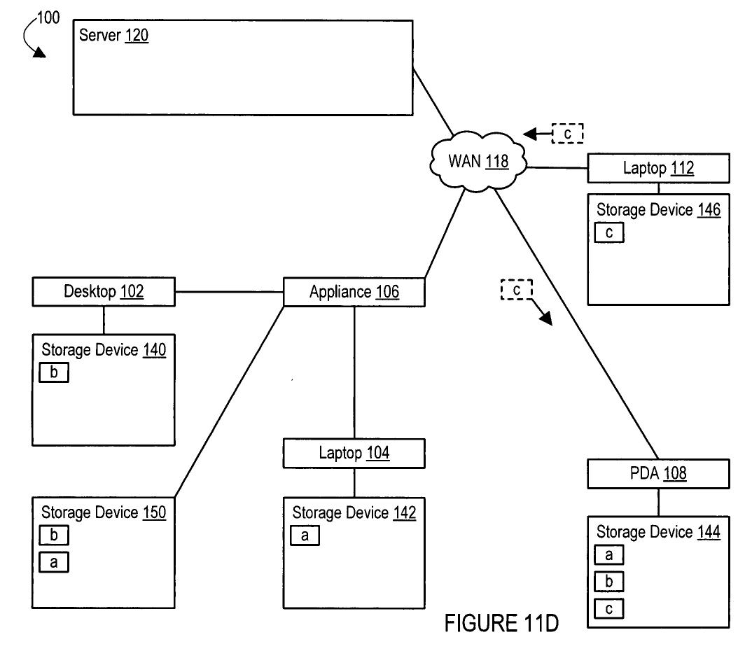

In one embodiment, a computing device may distribute and/or synchronize content without being associated with an appliance. Accordingly, while appliances have advantages, the networking system 100 does not require any appliances. For example, FIG. 11A is a block diagram that illustrates an embodiment of the networking system 100 in which one or more computing devices may distribute and/or synchronize content in any suitable manner without using an appliance.

In one embodiment, some or all of a set of computing devices do not require an appliance and may distribute and/or synchronize content in any suitable manner. For example, FIGS. 11B-11D are block diagrams of an embodiment of the networking system 100 in which appliances may be optional.

As shown in FIG. 11B, a file “a” may be stored on the storage device 144 of the PDA 108. Also, a file “b” may be stored on the storage device 140 of the desktop 102, may be stored on the storage device 150 of the appliance 106, or both. Also, a file “c” may be stored on the storage device 146 of the laptop 112.

As shown in FIGS. 1A and 11B, the content management module 134 for the PDA 108 may retrieve a copy of the file “a” from the storage device 144. The content management module 134 may send a copy of the file “a” to the appliance 106. The content management module 122 for the appliance 106 may receive the copy of the file “a,” may store the copy of the file “a” in the storage device 150, and may send the copy of the file “a” to the laptop 104. The content management module 132 for the laptop 104 may receive the copy of the file “a” and may store the copy of the file “a” in the storage device 142.

As shown in FIGS. 1A and 11C, the content management module 130 for the desktop 102 may retrieve a copy of the file “b” from the storage device 140. The content management module 130 may send a copy of the file “b” to the appliance 106. The content management module 122 for the appliance 106 may receive the copy of the file “b,” may store the copy of the file “b” in the storage device 150, and may send the copy of the file “b” to the PDA 108. The content management module 134 for the PDA 108 may receive the copy of the file “b” and may store the copy of the file “b” in the storage device 144.

As shown in FIGS. 1A and 11D, the content management module 136 for the laptop 112 may retrieve a copy of the file “c” from the storage device 146. The content management module 136 may send a copy of the file “c” to the PDA 108. The content management module 134 for the PDA 108 may receive the copy of the file “c” and may store the copy of the file “c” in the storage device 144.

As shown in FIGS. 11A-11D, a plurality of computing devices may distribute content with or without the use of any appliance. Of course, if desired, a plurality of computing devices may distribute and/or synchronize content in any suitable fashion and for any suitable purpose with or without the use of any appliance.

Remotely Accessing Content

In one embodiment, a person may advantageously access content using a computing device generally uninvolved with the distribution and/or the synchronization of the particular content. For example, a businessperson may use an appliance to distribute and/or synchronize content among a few desktop computers at the businessperson's office. Away on a business trip, the businessperson may remember some forgotten data files and may advantageously use a laptop to access those data files stored on a storage device associated with the appliance. Also, as an example, a person may use an appliance to backup photographs from a family reunion. Using a web browser, the family members may advantageously access a server that may advantageously retrieve one or more images files of the family reunion that are stored in a storage device associated with the appliance. Of course, any person could access content for any of a variety of other purposes. Further, any person could access content using any of a variety of other suitable computing devices, appliances, and the like.

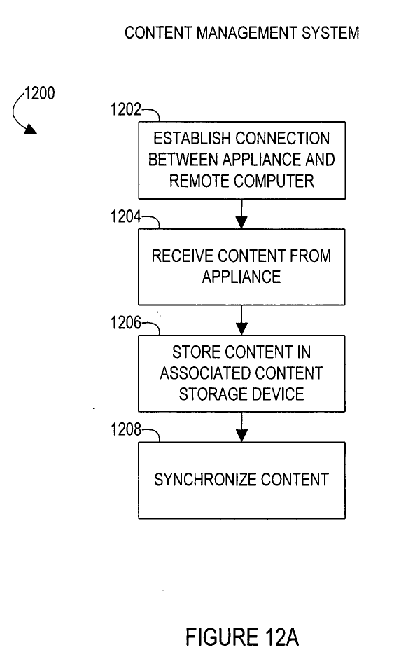

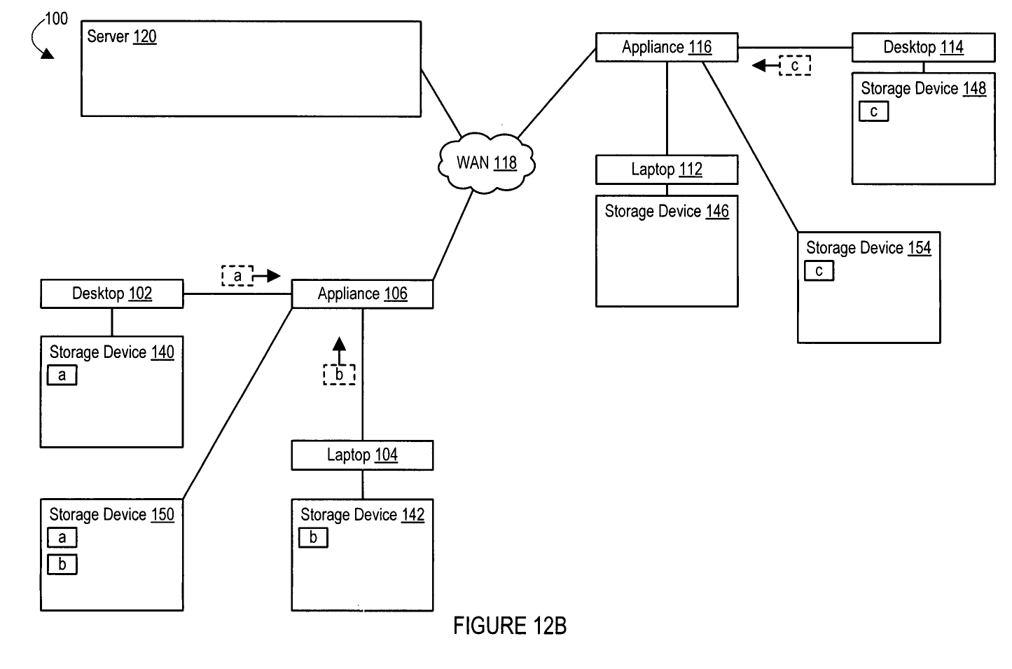

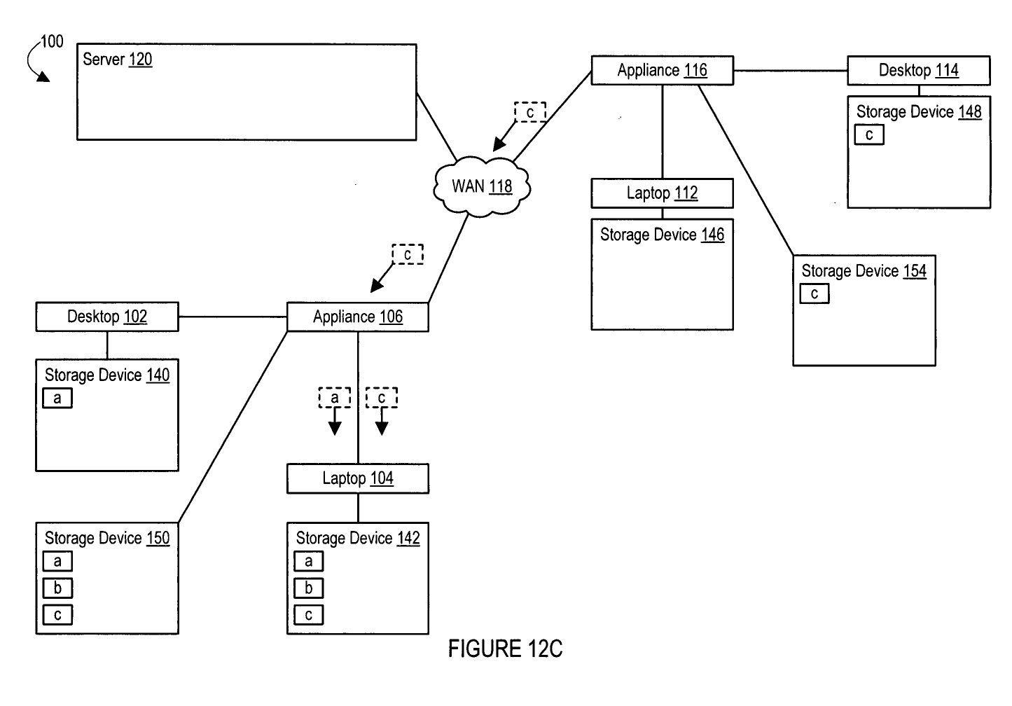

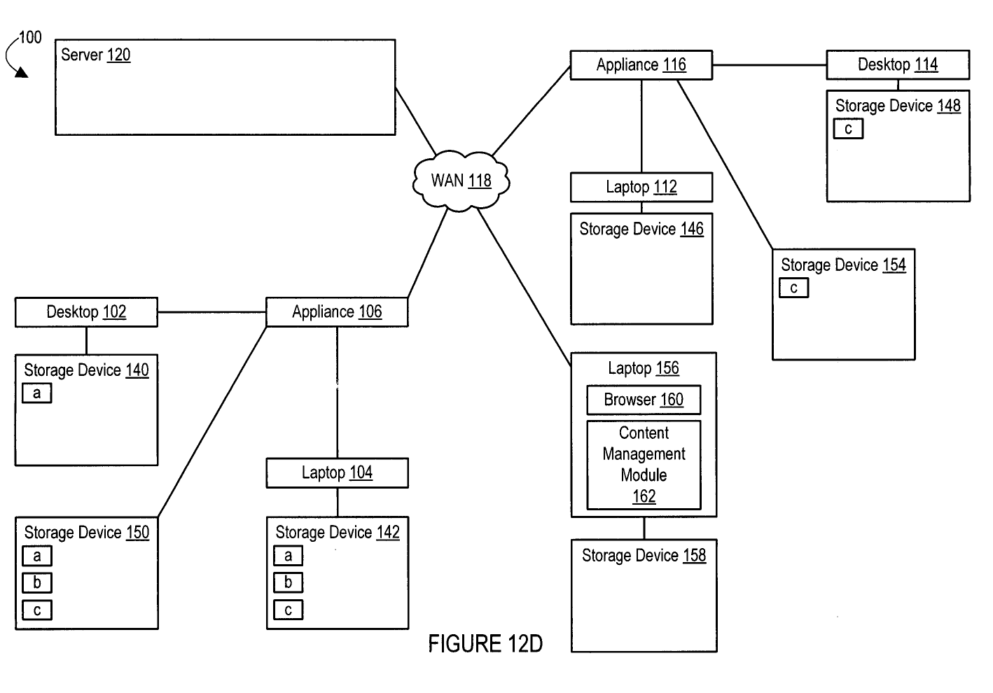

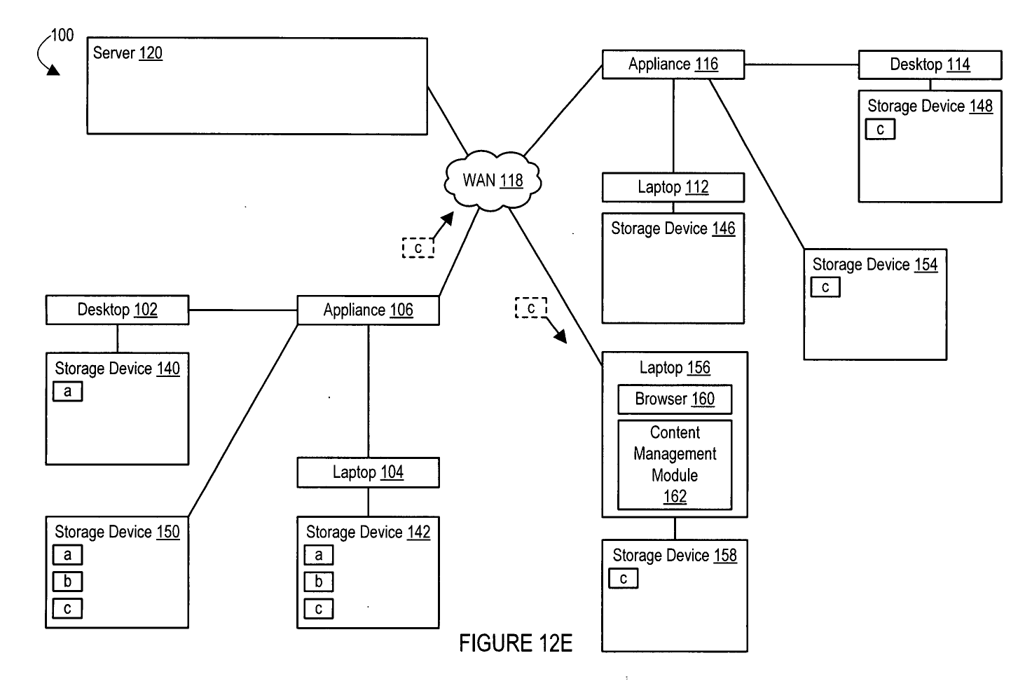

In one embodiment, a computing device (such as, a remote computer) may access content distributed and/or synchronized by one or more other computing devices, one or more appliances, and the like. FIG. 12A is a flowchart illustrating an exemplary method 1200 that may be performed using any suitable system, such as, the networking environment 100 shown in FIGS. 1A and 1B. In one embodiment, a content management system may perform some or all of the method 1200. The method 1200 may be performed by any other suitable system and in any other suitable environment.

As shown in FIG. 12A, at a block 1202, a connection may be established between an appliance and a computing device (such as, a remote computer) using any suitable connection, protocol, or the like. The connection may be directly established via a network (such as, the WAN 118), may be indirectly established and/or brokered via a server (such as, the server 120), or may be established in any other suitable fashion. For example, a content management module for the remote computer, a content management module for the appliance, a content management module for a server, a web browser associated with the remote computer, or any combination thereof may establish a connection. Any other suitable components or devices could establish a connection.

At a block 1204, the remote computer may receive content from the appliance directly via a network, indirectly brokered via a server, or in any other suitable manner. For example, a content management module for the appliance could send the content to the remote computer directly via a network, could send the content to a server (which could send the content to the remote computer), or could send the content in any other suitable fashion. A content management module for the remote computer may receive the content, and, at a block 1206, may store the received content in a storage device associated with the remote computer.

At a block 1208, a content management module for the remote computer, a content management module for the appliance, a content management module for a server, a web browser associated with the remote computer, or any combination thereof may optionally synchronize and/or further distribute the received content in any suitable manner. For example, as described above, a computer need not use an appliance to distribute and/or synchronize content. Accordingly, if desired, the remote computer may advantageously be configured to synchronize and/or further distribute the received content. Of course, the remote computer need not synchronize and/or further distribute the received content.

FIGS. 12B-12E are block diagrams of an embodiment of the networking system 100 in which some or all of the method 1200 (FIG. 12A) may be performed.

One or more computing devices, appliances, and the like may advantageously distribute and/or synchronize content. For example, as shown in FIGS. 1A and 12B, a plurality of computing devices may distribute content to various appliances. As shown, the content management module 130 for the desktop 102 may retrieve a copy of the file “a” from the storage device 140. The content management module 130 may send a copy of the file “a” to the appliance 106. The content management module 122 for the appliance 106 may receive the copy of the file “a” and may store the copy of the file “a” in the storage device 150. Also, the content management module 132 for the laptop 104 may retrieve a copy of the file “b” from the storage device 142. The content management module 132 may send a copy of the file “b” to the appliance 106. The content management module 122 for the appliance 106 may receive the copy of the file “b” and may store the copy of the file “b” in the storage device 150. Also, the content management module 138 for the desktop 114 may retrieve a copy of the file “c” from the storage device 148. The content management module 138 may send a copy of the file “c” to the appliance 116. The content management module 126 for the appliance 116 may receive the copy of the file “c” and may store the copy of the file “c” in the storage device 154.

As shown in FIGS. 1A and 12C, the content may be distributed further. For example, the content management module 122 for the appliance 106 may retrieve a copy of the file “a” in any suitable manner and may send a copy of the file “a” to the laptop 104. The content management module 132 for the laptop 104 may receive the copy of the file “a” and may store the copy of the file “a” in the storage device 142. Also, the content management module 126 for the appliance 116 may retrieve a copy of the file “c” and may send the copy of the file “c” to the appliance 106. The content management module 122 for the appliance 106 may receive the copy of the file “c,” may store the copy of the file “c” in the storage device 150, and may send the copy of the file “c” to the laptop 104. The content management module 132 for the laptop 104 may receive the copy of the file “c” and may store the copy of the file “c” in the storage device 142.

As shown in FIG. 12D, a computing device (such as, a laptop 156) may advantageously connect to the WAN 118 in any suitable manner. The computing device may include one or more associated storage devices (such as, the storage device 158), a web browser (such as, a web browser 160), and/or a content management module (such as, a content management module 162).

As shown in FIG. 12E, the laptop 156 may connect to the WAN to distribute and/or synchronize content. In one embodiment, the browser 160, the content management module 162, or both may request access to content. In response to receiving the request, one or more content management modules associated with an appliance, a computing device, a server, or a combination thereof may send the content to the laptop 156.

For example, as shown in FIGS. 1A and 12E, the content management module 122 for the appliance 106 may retrieve a copy of the file “c” in any suitable manner. The content management module 122 may send a copy of the file “c” to the laptop 156. The content management module 162 for the laptop 156 may receive the file “c” and may store the file “c” on the storage device 158.

As another example, a person—using the browser 160 to access a website, a web application, or the like hosted by the server 120—may view from the website a displayed set of content that the person may access. Upon receiving user input identifying user-selected content from the set of available content, the server 120 may use the content management module 128 to request the content from the appliance 106. The appliance 106 may send the content directly to the laptop 156, may send the content to the content management module 128 (which may send the content to the laptop 156), or may send the content in any other suitable manner.

As shown in FIG. 12E, it will be appreciated that the laptop 156 may be (but need not be) remotely located from some or all of the appliances 106 and 166, the desktops 102 and 114, the laptops 104 and 112, the server 120, and any associated storage devices. Of course, the laptop 156 may be in any suitable location relative to any other component of the networking environment 100. Further, although the laptop 156 may be a computing device generally uninvolved with the prior distribution and/or synchronization of content (such as, the files “a,” “b,” and “c”), it will be appreciated that any device may be configured as the laptop 156 without regard to whether the device was involved with the prior distribution and/or synchronization of content. For example, if desired, the laptop 104 could be disconnected from the appliance 106 and connected to the WAN 118 to continue the distribution and/or synchronization of content. Of course, any other suitable computing devices may access, distribute, and/or synchronize content in any other suitable manner.

For example, in one embodiment the content management module 128 of the server 120 may be configured to help authenticate and/or facilitate communication among two or more appliances, computing devices, web browsers, or the like. Accordingly, if desired, two or more appliances, computing devices, web browsers, or the like may establish communication and authenticate with each other.

In one embodiment, the content management module 128 of the server 120 may be configured to facilitate communication among two or more appliances, computing devices, web browsers, or the like.

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module—such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (FPGAs), application-specific integrated circuits (ASICs), controllers, computers, and firmware to implement those methods described above. The functionality provided for in the software, hardware, or both may be combined into fewer components or further separated into additional components. Additionally, the components may advantageously be implemented to execute on one or more computing devices.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The methods and systems described above require no particular component or function. Thus, any described component or function—despite its advantages—is optional. Also, some or all of the described components and functions may be used in connection with any number of other suitable components and functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a networking environment that includes a first local area network including a first storage device, a first computing device, and a first appliance associated with the first computing device; and a second local area network including a second storage device, a second computing device, and a second appliance associated with the second computing device; the method comprising:
receiving data indicating a request for a content distribution relationship, the content distribution relationship including an initial transmission of first content stored at the first storage device to the second storage device for storage as second content at the second storage device, the second content comprising a copy of the first content, the initial transmission at least partially made via the first appliance, the initial transmission at least partially made via the second appliance;
displaying the request; and
receiving a response to the request.

2. The method of claim 1, wherein the content distribution relationship comprises a content backup relationship.

3. The method of claim 1, wherein the content distribution relationship comprises a content subscription relationship.

4. The method of claim 1, wherein the content distribution relationship includes a subsequent transmission of third content stored at the first storage device to the second storage device for storage as fourth content at the second storage device; the third content comprising another version of the first content; the fourth content comprising a copy of the third content; the subsequent transmission at least partially made via the first appliance; the subsequent transmission at least partially made via the second appliance.

5. The method of claim 1, wherein the content distribution relationship includes a subsequent transmission of third content stored at the second storage device to the first storage device for storage as fourth content at the first storage device; the third content comprising another version of the second content; the fourth content comprising a copy of the third content; the subsequent transmission at least partially made via the first appliance; the subsequent transmission at least partially made via the second appliance.

6. The method of claim 1, wherein the first computing device includes the first storage device, and wherein the second computing device includes the second storage device.

7. The method of claim 1, wherein the first appliance includes the first storage device, and wherein the second appliance includes the second storage device.

8. The method of claim 1, wherein a set of one or more rules define the content relationship and wherein the set of one or more rules are applied using one or more content management modules at least partially implemented within each of the first computing device, the first appliance, the second computing device, and the second appliance.

9. A networking system including:
a first storage device;
a second storage device
a first appliance;
a first computing device associated with the first appliance, the first computing device configured to create first data indicating a request for a content relationship; and
a second computing device configured to receive second data indicating the request for the content relationship, to display the request at least partially in response to receiving the second data, and to receive a user input indicating a user response to the request;
wherein the content relationship includes an initial transmission of first content stored at the first storage device to the second storage device for storage as second content at the second storage device; the second content comprising a copy of the first content; the initial transmission at least partially made via the first appliance.

10. The networking system of claim 9, wherein the content distribution relationship comprises a content backup relationship.

11. The networking system of claim 9, wherein the content distribution relationship comprises a content subscription relationship.

12. The networking system of claim 9, wherein the content distribution relationship includes a subsequent transmission of third content stored at the first storage device to the second storage device for storage as fourth content at the second storage device; the third content comprising another version of the first content; the fourth content comprising a copy of the third content; the subsequent transmission at least partially made via the first appliance.

13. The networking system of claim 9, wherein the content distribution relationship includes a subsequent transmission of third content stored at the second storage device to the first storage device for storage as fourth content at the first storage device; the third content comprising another version of the second content; the fourth content comprising a copy of the third content; the subsequent transmission at least partially made via the first appliance.

14. The networking system of claim 9, wherein the second data is the first data.

15. In a network including a first storage device, a first computing device, a second storage device, a second computing device, and a first appliance associated with the first computing device; the method comprising:
creating first data indicating a request for a content distribution relationship, the content distribution relationship including an initial transmission of first content stored at the first storage device to the second storage device for storage as second content at the second storage device, the second content comprising a copy of the first content, the initial transmission at least partially made via the first appliance;
transmitting the first data; and
receiving second data indicating a user response to the request.

16. The method of claim 15, wherein the content distribution relationship comprises a content backup relationship.

17. The method of claim 15, wherein the content distribution relationship comprises a content subscription relationship.

18. The method of claim 15, wherein the first computing device and the first appliance are configured to communicate at least partially via a wireless communication connection.

19. The method of claim 15, wherein the first appliance is associated with the second computing device and wherein the second computing device and the appliance are configured to communicate at least partially via a wireless communication connection.

20. The method of claim 15, wherein a set of one or more rules define the content relationship and wherein the set of one or more rules are applied using one or more content management modules at least partially implemented within each of the first computing device, the appliance, the second computing device, and a server.

21. The method of claim 15, wherein the network further includes a server and a second appliance, the second appliance associated with the second computing device, the server facilitating communication between the first appliance and the second appliance.
